(19) United States
(12) Patent Application Publication
(10) Pub. No.: US 2022/0403913 A1
(43) Pub. Date: Dec. 22, 2022

(54) VIBRATION ISOLATOR

(71) Applicant: DENSO CORPORATION, Kariya-city (JP)

(72) Inventors: Kazuhiro HAYASHI, Nisshin-city (JP); Yasumasa YAMAZAKI, Nisshin-city (JP); Motohiko UEDA, Kariya-city (JP)

(73) Assignee: DENSO CORPORATION, Kariya-city (JP)

(21) Appl. No.: 17/730,437

(22) Filed: Apr. 27, 2022

(30) Foreign Application Priority Data
Jun. 16, 2021 (JP) 2021-100263

(51) Int. Cl. F16F 15/073

(52) U.S. Cl. CPC F16F 15/073; F16F 2222/04; F16F 2238/022

(57) ABSTRACT

Primary plate springs overlap a first plate spring segment of a coupling plate spring in a first direction and respectively have a frictional contact portion which generates sliding friction relative to the first plate spring segment in response to vibrations, Secondary plate springs overlap a second plate spring segment of the coupling plate spring in a second direction and respectively have a frictional contact portion which generates sliding friction relative to the second plate spring segment in response to the vibrations while the second direction is different from the first direction. Tertiary plate springs overlap a third plate spring segment of the coupling plate spring in a third direction and respectively have a frictional contact portion which generates sliding friction relative to the third plate spring segment in response to the vibrations while the third direction is different from the first and second directions.

### CROSS REFERENCE TO RELATED APPLICATION

This application is based on and incorporates herein by reference Japanese Patent Application No. 2021-100263 filed on Jun. 16, 2021.

### TECHNICAL FIELD

The present disclosure relates to a vibration isolator.

### BACKGROUND

There has been proposed a vibration isolator that includes a laminated spring having a plurality of elongated plate springs which have different lengths, respectively, and are laminated in a top-to-bottom direction. The laminated spring can attenuate vibration,

### SUMMARY

This section provides a general summary of the disclosure, and is not a comprehensive disclosure of its full scope or all of its features.

According to the present disclosure, there is provided a vibration isolator configured to limit conduction of vibrations, which are generated at a vibration source, to a vibration receiving object. The vibration isolator includes a coupling plate spring and a plate spring. The coupling plate spring is configured to couple between the vibration source and the vibration receiving object. The plate spring has a frictional contact portion that is configured to generate sliding friction relative to the plate spring segment in response to the vibrations.

### BRIEF DESCRIPTION OF DRAWINGS

The drawings described herein are for illustrative purposes only of selected embodiments and not all possible implementations, and are not intended to limit the scope of the present disclosure.

FIG. 1 is a front view showing an overall structure of a vehicular vibration isolator of a first embodiment of the present disclosure.

FIG. 2 is a top view showing the overall structure of the vehicular vibration isolator of the first embodiment shown in FIG. 1.

FIG. 3 is a side view showing the overall structure of the vehicular vibration isolator of the first embodiment shown in FIG. 1.

FIG. 4 is a perspective view showing the overall structure of the vehicular vibration isolator of the first embodiment shown in FIG. 1.

FIG. 5 is a diagram for assisting an explanation of structures of a coupling plate spring and plate springs of a spring unit of the vehicular vibration isolator of the first embodiment shown in FIG. 1.

FIG. 6 is a diagram for assisting an explanation of manufacturing of the coupling plate spring of the spring unit of the vehicular vibration isolator of the first embodiment shown in FIG. 1.

FIG. 7 is a diagram for assisting an explanation of the coupling plate spring of the spring unit of the vehicular vibration isolator of the first embodiment shown in FIG. 1.

FIG. 8 is a diagram for assisting an explanation of a vibration isolating effect of the vehicular vibration isolator of the first embodiment shown in FIG. 1.

FIG. 9 is a diagram for assisting an explanation of an experiment for measuring the vibration isolating effect of the vehicular vibration isolator of the first embodiment shown in FIG. 1.

FIG. 10 is a diagram for assisting an explanation of a measurement result of the vibration isolating effect of the vehicular vibration isolator of the first embodiment shown in FIG. 1.

FIG. 11 is a diagram for assisting the explanation of the measurement result of the vibration isolating effect of the vehicular vibration isolator of the first embodiment shown in FIG. 1.

FIG. 12 is a diagram for assisting the explanation of the measurement result of the vibration isolating effect of the vehicular vibration isolator of the first embodiment shown in FIG. 1.

FIG. 13 is a diagram for assisting an explanation of an experiment for measuring the vibration isolating effect of the vehicular vibration isolator of the first embodiment shown in FIG. 1.

FIG. 14 is a diagram for assisting an explanation of a measurement result of the vibration isolating effect of the vehicular vibration isolator of the first embodiment shown in FIG. 1.

FIG. 15 is a diagram for assisting the explanation of the measurement result of the vibration isolating effect of the vehicular vibration isolator of the first embodiment shown in FIG. 1.

FIG. 16 is a diagram for assisting the explanation of the measurement result of the vibration isolating effect of the vehicular vibration isolator of the first embodiment shown in FIG. 1,

FIG. 17 is a diagram for assisting an explanation of structures of a coupling plate spring and plate springs of a spring unit of a vehicular vibration isolator in a modification of the first embodiment.

FIG. 18 is a front view showing an overall structure of a vehicular vibration isolator of a second embodiment of the present disclosure.

FIG. 19 is a partial enlarged view of an area Xa of the vehicular vibration isolator of the second embodiment shown in FIG. 18.

FIG. 20 is a diagram for assisting an explanation of a vibration isolating effect of the vehicular vibration isolator of the second embodiment shown in FIG. 18.

FIG. 21 is a diagram for assisting the explanation of the vibration isolating effect of the vehicular vibration isolator of the second embodiment shown in FIG. 18.

FIG. 22 is a diagram for assisting the explanation of the vibration isolating effect of the vehicular vibration isolator of the second embodiment shown in FIG. 18.

FIG. 23 is a front view showing a portion of a vehicular vibration isolator of a third embodiment of the present disclosure.

FIG. 24 is a front view showing a portion of a vehicular vibration isolator in a first modification of the third embodiment of the present disclosure.

FIG. 25 is a front view showing a portion of a vehicular vibration isolator in a second modification of the third embodiment of the present disclosure.

FIG. 26 is a front view showing a portion of a vehicular vibration isolator in a third modification of the third embodiment of the present disclosure.

FIG. 27 is a front view showing a portion of a vehicular vibration isolator in a fourth modification of the third embodiment of the present disclosure.

FIG. 28 is a front view showing a portion of a vehicular vibration isolator of a fourth embodiment of the present disclosure.

FIG. 29 is a front view showing a portion of a vehicular vibration isolator in a first modification of the fourth embodiment of the present disclosure.

FIG. 30 is a partial enlarged view of the vehicular vibration isolator in the first modification of the fourth embodiment shown in FIG. 29.

FIG. 31 is a diagram for assisting an explanation of an effect of the vehicular vibration isolator in the first modification of the fourth embodiment shown in FIG. 29.

FIG. 32 is a diagram for assisting the explanation of the effect of the vehicular vibration isolator in the first modification of the fourth embodiment shown in FIG. 29.

FIG. 33 is a diagram for assisting the explanation of the effect of the vehicular vibration isolator in the first modification of the fourth embodiment shown in FIG. 29.

FIG. 34 is a front view showing a portion of a vehicular vibration isolator in a second modification of the fourth embodiment of the present disclosure.

FIG. 35 is a front view showing a portion of a vehicular vibration isolator in a third modification of the fourth embodiment of the present disclosure.

FIG. 36 is a front view showing a portion of a vehicular vibration isolator in a fourth modification of the fourth embodiment of the present disclosure.

FIG. 37 is a front view showing a portion of a vehicular vibration isolator in a fifth modification of the fourth embodiment of the present disclosure.

FIG. 38 is a front view showing a portion of a vehicular vibration isolator of a fifth embodiment of the present disclosure,

FIG. 39 is a front view showing a portion of a vehicular vibration isolator of a sixth embodiment of the present disclosure.

FIG. 40 is a front view showing a portion of a vehicular vibration isolator of a seventh embodiment of the present disclosure.

FIG. 41 is a front view showing a portion of a vehicular vibration isolator of an eighth embodiment of the present disclosure.

FIG. 42 is a front view showing a portion of a vehicular vibration isolator of a ninth embodiment of the present disclosure.

FIG. 43 is a front view showing an overall structure of a vehicular vibration isolator of a tenth embodiment of the present disclosure.

FIG. 44 is a diagram for assisting an explanation of a manufacturing process of a spring unit of the vehicular vibration isolator of the tenth embodiment shown in FIG. 43.

FIG. 45 is a diagram for assisting the explanation of the manufacturing process of the spring unit of the vehicular vibration isolator of the tenth embodiment shown in FIG. 43.

FIG. 46 is a diagram for assisting an explanation of a vibration isolating effect of the spring unit of the vehicular vibration isolator of the tenth embodiment shown in FIG. 43.

FIG. 47 is a diagram for assisting the explanation of the vibration isolating effect of the spring unit of the vehicular vibration isolator of the tenth embodiment shown in FIG. 43.

FIG. 48 is a diagram for assisting the explanation of the vibration isolating effect of the spring unit of the vehicular vibration isolator of the tenth embodiment shown in FIG. 43.

FIG. 49 is a diagram for assisting the explanation of the vibration isolating effect of the spring unit of the vehicular vibration isolator of the tenth embodiment shown in FIG. 43.

FIG. 50 is a front view showing an overall structure of a vehicular vibration isolator of an eleventh embodiment of the present disclosure.

FIG. 51 is a diagram for assisting an explanation of a vibration isolating effect of a spring unit of the vehicular vibration isolator of the eleventh embodiment shown in FIG. 50.

FIG. 52 is a diagram for assisting the explanation of the vibration isolating effect of the spring unit of the vehicular vibration isolator of the eleventh embodiment shown in FIG. 50.

FIG. 53 is a front view showing an overall structure of a vehicular vibration isolator of a twelfth embodiment of the present disclosure.

FIG. 54 is a front view showing an overall structure of a vehicular vibration isolator of a thirteenth embodiment of the present disclosure.

FIG. 55 is a perspective view showing an overall structure of a vehicular vibration isolator of a fourteenth embodiment of the present disclosure.

FIG. 56 is a front view showing an overall structure of the vehicular vibration isolator of the fourteenth embodiment shown in FIG. 55.

FIG. 57 is a diagram for assisting an explanation of a vibration isolating effect of a spring unit of the vehicular vibration isolator of the fourteenth embodiment shown in FIG. 55.

FIG. 58 is a diagram for assisting the explanation of the vibration isolating effect of the spring unit of the vehicular vibration isolator of the fourteenth embodiment shown in FIG. 55.

FIG. 59 is a diagram for assisting the explanation of the vibration isolating effect of the spring unit of the vehicular vibration isolator of the fourteenth embodiment shown in FIG. 55.

FIG. 60 is a diagram for assisting the explanation of the vibration isolating effect of the spring unit of the vehicular vibration isolator of the fourteenth embodiment shown in FIG. 55.

FIG. 61 is a partial enlarged view showing a portion of a vehicular vibration isolator of a fifteenth embodiment of the present disclosure.

FIG. 62 is a diagram showing an overall structure of a vehicular vibration isolator of a sixteenth embodiment of the present disclosure.

FIG. 63 is a diagram showing an overall structure of a vehicular vibration isolator of another embodiment of the present disclosure.

FIG. 64 is a diagram showing an overall structure of a vehicular vibration isolator of another embodiment of the present disclosure.

FIG. 65 is a diagram showing an overall structure of a vehicular vibration isolator of another embodiment of the present disclosure.

FIG. 66 is a diagram showing an overall structure of a vehicular vibration isolator of another embodiment of the present disclosure.

FIG. 67 is a diagram showing an overall structure of a vehicular vibration isolator of another embodiment of the present disclosure.

FIG. 68 is a diagram showing an overall structure of a vehicular vibration isolator of another embodiment of the present disclosure.

FIG. 69 is a diagram showing an overall structure of a vehicular vibration isolator of another embodiment of the present disclosure.

### DETAILED DESCRIPTION

There has been proposed a vibration isolator that includes a laminated spring having a plurality of elongated plate springs which have different lengths, respectively, and are laminated in a top-to-bottom direction. The laminated spring can attenuate vibration in the top-to-bottom direction by generating sliding friction between each adjacent two of the elongated plate springs when the elongated plate springs are flexed by the vibration.

As discussed above, at the vibration isolator, the laminated spring can attenuate the vibration in the top-to-bottom direction by generating the sliding friction between each adjacent two of the elongated plate springs when the elongated plate springs are flexed by the vibration. However, the laminated spring cannot attenuate the vibrations in other directions which are other than the top-to-bottom direction.

According to a first aspect of the present disclosure, there is provided a vibration isolator configured to limit conduction of vibrations, which are generated at a vibration source, to a vibration receiving object, the vibration isolator including;

a coupling plate spring that has a first plate spring segment, a second plate spring segment and a third plate spring segment and is configured to couple between the vibration source and the vibration receiving object through the first plate spring segment, the second plate spring segment and the third plate spring segment;

a primary plate spring that is arranged to overlap the first plate spring segment in a first direction and is fixed to the first plate spring segment, wherein the primary plate spring has a primary frictional contact portion that is configured to generate sliding friction relative to the first plate spring segment in response to the vibrations;

a secondary plate spring that is arranged to overlap the second plate spring segment in a second direction and is fixed to the second plate spring segment while the second direction is different from the first direction, wherein the secondary plate spring has a secondary frictional contact portion that is configured to generate sliding friction relative to the second plate spring segment in response to the vibrations; and

a tertiary plate spring that is arranged to overlap the third plate spring segment in a third direction and is fixed to the third plate spring segment while the third direction is different from the first direction and the second direction, wherein the tertiary plate spring has a tertiary frictional contact portion that is configured to generate sliding friction relative to the third plate spring segment in response to the vibrations.

Therefore, the vibration in the first direction, the vibration in the second direction and the vibration in the third direction can be attenuated. Thus, the vibrations, which are conducted from the vibration source to the vibration receiving object, can be further attenuated.

According to a second aspect of the present disclosure, there is provided a vibration isolator configured to limit conduction of vibrations, which are generated at a vibration source, to a vibration receiving object, the vibration isolator including:

a coupling plate spring that is configured to couple between the vibration source and the vibration receiving object; and

a plate spring that has:
a fixing portion, which is fixed to the coupling plate spring; and
a plurality of frictional contact portions, which are arranged to overlap the coupling plate spring at corresponding locations, respectively, that are different from a location of the fixing portion, wherein the plurality of frictional contact portions are respectively configured to generate sliding friction relative to the coupling plate spring in response to the vibrations.

Thus, by providing the plurality of frictional contact portions at the plate spring, the plate spring can generate the sliding friction at different frequencies, respectively. Thereby, vibrations at a plurality of frequencies can be attenuated. Therefore, the vibrations, which are conducted from the vibration source to the vibration receiving object, can be further attenuated.

According to a third aspect of the present disclosure, there is provided a vibration isolator configured to limit conduction of vibrations, which are generated at a vibration source, to a vibration receiving object, the vibration isolator including:

a coupling plate spring that is configured to couple between the vibration source and the vibration receiving object; and

a plate spring that has:
a fixing portion, which is fixed to the coupling plate spring; and
a frictional contact portion, which is arranged to overlap the coupling plate spring at a corresponding location that is different from a location of the fixing portion, wherein the frictional contact portion is configured to generate sliding friction relative to the coupling plate spring in response to the vibrations in a state where a resilient force is applied from the plate spring to the coupling plate spring through resilient deformation of the plate spring.

Thus, the frictional contact portion of the plate spring generates the sliding friction relative to the coupling plate spring in response to the vibration in the state where the resilient force is applied from the plate spring to the coupling plate spring through the resilient deformation of the plate spring. Thus, the vibrations, which are conducted from the vibration source to the vibration receiving object, can be further attenuated.

According to a fourth aspect of the present disclosure, there is provided a vibration isolator configured to limit conduction of vibrations, which are generated at a vibration source, to a vibration receiving object, the vibration isolator including:

a coupling plate spring that has a plate spring segment and is configured to couple between the vibration source and the vibration receiving object through the plate spring segment; and

a plate spring that has:
a fixing portion, which is fixed to the plate spring segment;
a frictional contact portion which is arranged to overlap the plate spring segment at a corresponding location that is different from a location of the fixing portion, wherein the frictional contact portion is configured to generate sliding friction relative to the plate spring segment in response to the vibrations; and
a displacement enabling portion which is configured to be resiliently deformed in response to the vibrations to displace the frictional contact portion relative to the plate spring segment.

Therefore, wear particles, which are generated by the sliding friction of the frictional contact portion relative to the plate spring segment of the coupling plate spring, can be expelled from the location between the plate spring segment and the frictional contact portion. As a result, it is possible to limit acceleration of the wearing of the plate spring segment and the frictional contact portion.

Embodiments of the present disclosure will be described with reference to the drawings. In each of the following embodiments, portions, which are the same or equal to each other, are designated by the same reference signs in the drawings in order to simplify the description.

### First Embodiment

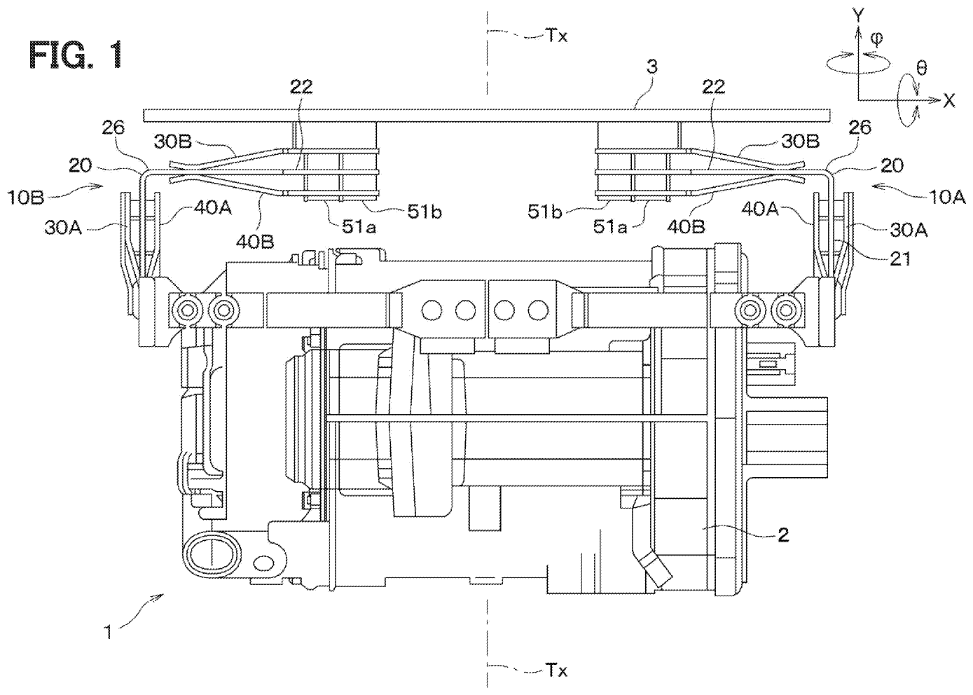

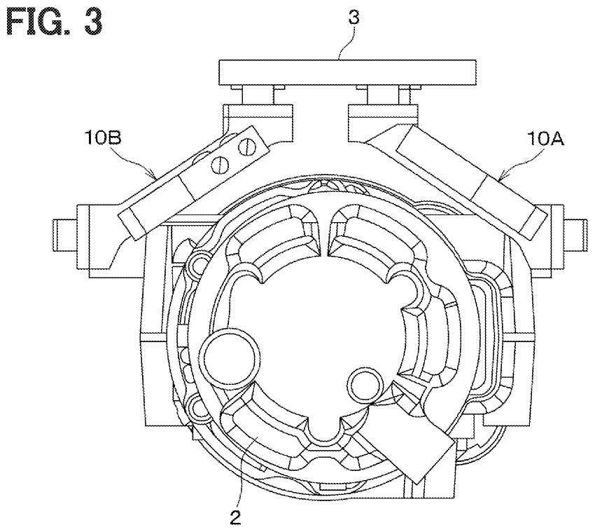

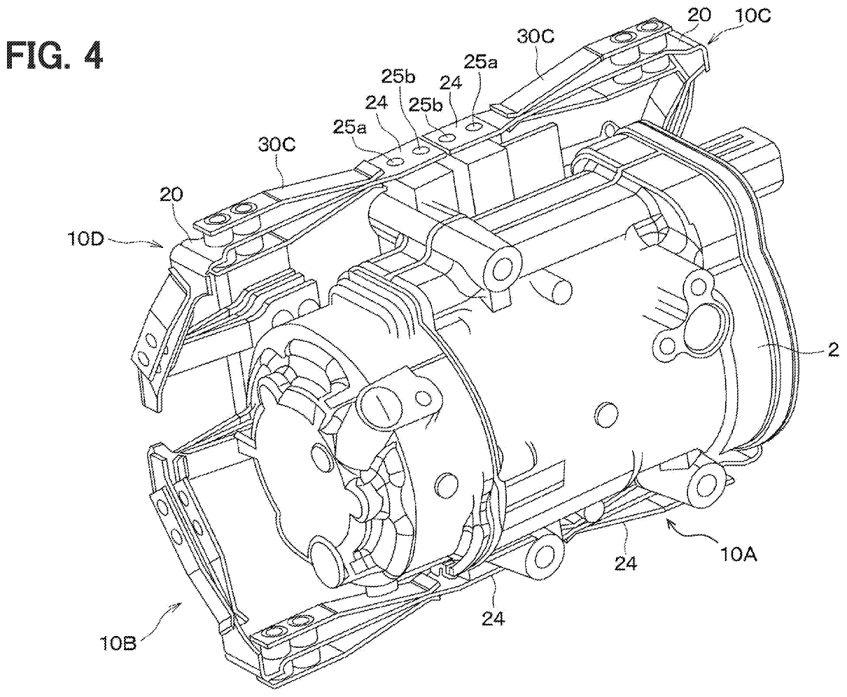

A vibration isolator (hereinafter referred to as a vehicular vibration isolator) 1 for a motor vehicle (or simply referred to as a vehicle) according to a first embodiment of the present disclosure will be described with reference to FIGS. 1 to 4. Hereinafter, for convenience of explanation, there is set a Cartesian coordinate system having an X direction (i.e., an axial direction of an X axis) , a Y direction (i.e., an axial direction of a Y-axis) and a Z direction (i.e., an axial direction of a Z axis), which are perpendicular to each other. Furthermore, in this Cartesian coordinate system, a swing direction around an axis extending in the X direction is defined as a θ direction, and a swing direction around an axis extending in the Y direction is defined as a φ direction, and a swing direction around an axis extending in the Z direction is defined as a ψ direction.

The vehicular vibration isolator 1 of the present embodiment is connected between a compressor 2 and a traveling engine 3 and limits conduction of vibrations, which are generated at the compressor 2, to the traveling engine 3.

In the present embodiment, the compressor 2 includes an electric motor and a compression mechanism and forms a vibration source that generates the vibrations. The traveling engine 3 is a vibration receiving object that supports the compressor 2. Besides the traveling engine 3, a vehicle body, an in-vehicle traveling electric motor or a transaxle may be used as the vibration receiving object, which supports the compressor 2.

Specifically, the vehicular vibration isolator 1 includes a plurality (four in this embodiment) of spring units (also referred to as laminated springs) 10A, 10B, 10C, 10D,

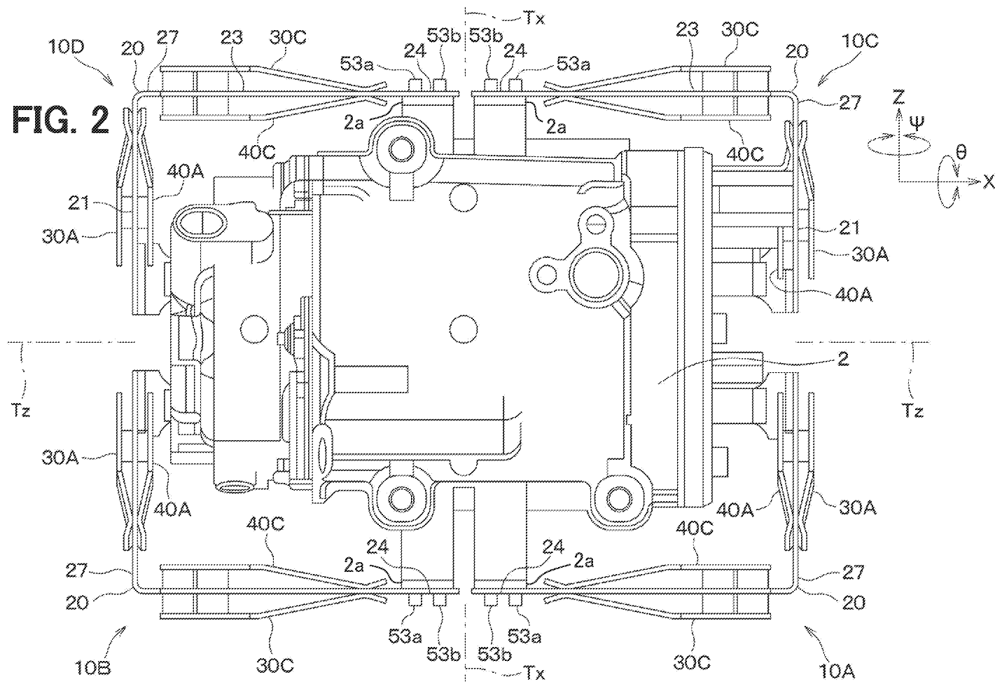

As shown in FIGS. 1 and 2, the spring units 10A, 10B are arranged to be plane-symmetric about an imaginary plane Tx that includes a central axis which is centered in the X direction. The spring units 10C, 10D are arranged to be plane-symmetric about the imaginary plane Tx that includes the central axis which is centered in the X direction. The spring units 10A, 10C are arranged to be plane-symmetric about an imaginary plane Tz that includes a central axis which is centered in the Z direction. The spring units 10B, 10D are arranged to be plane-symmetric about the imaginary plane Tz that includes the central axis which is centered in the Z direction.

Therefore, in the present embodiment, the spring unit 10A will be described with reference to FIGS. 1 to 7 as a representative example among the spring units 10A, 10B, 10C, 10D. The spring unit 10A includes a coupling plate spring 20 and a plurality of plate springs 30A, 30B, 30C, 40A, 40B, 40C which are made of metal. Alternative to the metal, the coupling plate spring 20 and the plurality of plate springs 30A, 30B, 30C, 40A, 40B, 40C may be made of another material, such as synthetic resin, fiber reinforced plastic, ceramic or the like.

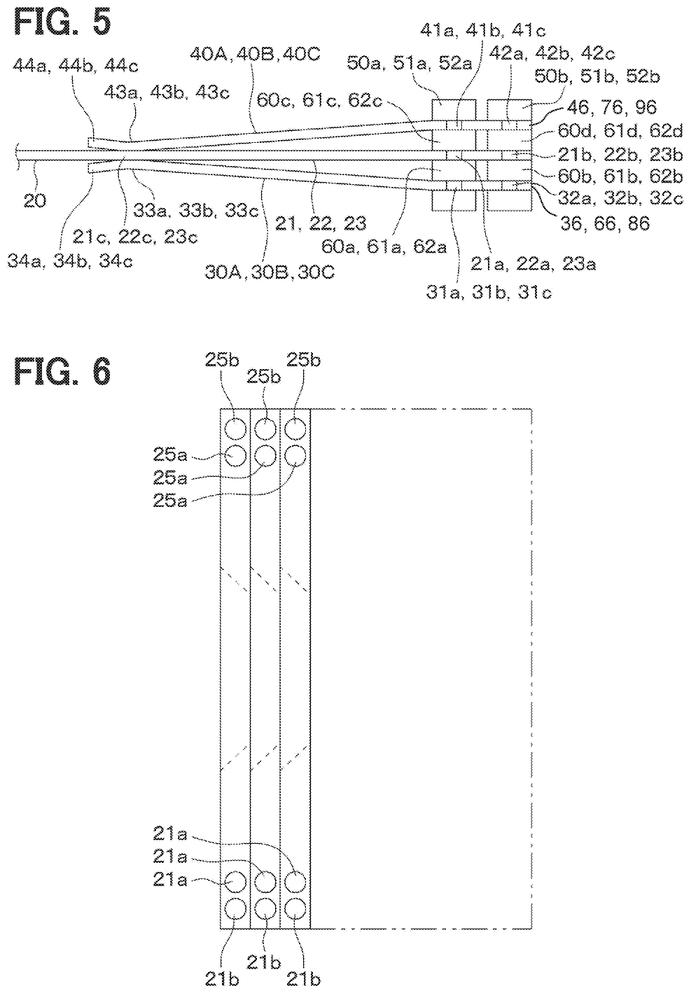

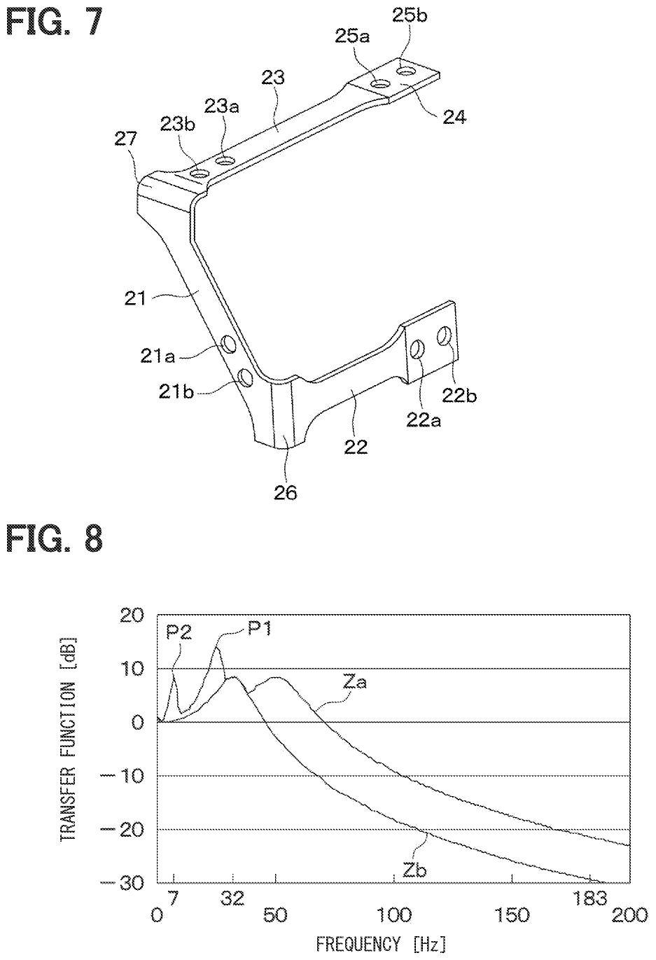

As shown in FIG. 5, the coupling plate spring 20 has a plurality of plate spring segments 21, 22, 23 and is configured to couple between the compressor 2 and the traveling engine 3 through the plate spring segments 21, 22, 23. As shown in FIGS. 6 and 7, the coupling plate spring 20 is elongated.

The plate spring segment 21 is a first plate spring segment and is shaped in an elongated plate form such that a longitudinal direction of the plate spring segment 21 coincides with the Y direction. A thickness direction of the plate spring segment 21 coincides with the X direction, and a width direction of the plate spring segment 21 coincides with the Z direction. A plurality (two in this embodiment) of through-holes 21a, 21b are formed at one longitudinal side of the plate spring segment 21.

The through-holes 21a, 21b are formed to receive bolts 50a, 50b, respectively. The plate spring segment 21 of the coupling plate spring 20 is joined to and is fixed to the plate springs 30A, 40A by the bolts 50a, 50b.

Therefore, the plate springs (serving as a pair of primary plate springs) 30A, 40A are fixed to the plate spring segment 21 of the coupling plate spring 20. A frictional contact portion 21c, which contacts a frictional contact portion 33a of the plate spring 30A and a frictional contact portion 43a of the plate spring 40A, is formed at the other longitudinal side of the plate spring segment 21.

The plate spring 30A is a primary plate spring and is arranged such that the plate spring 30A overlaps the plate spring segment 21 in the X direction (i.e., a first direction). The plate spring 30A is located on one side of the plate spring segment 21 in the thickness direction of the plate spring segment 21. The plate spring 30A is shaped in an elongated plate form such that a longitudinal direction of the plate spring 30A coincides with the Y direction. A thickness direction of the plate spring 30A coincides with the X direction, and a width direction of the plate spring 30A coincides with the Z direction. A plurality (two in this embodiment) of through-holes 31a, 32a are formed at one longitudinal side of the plate spring 30A to receive the bolts 50a, 50b, respectively. A fixing portion 36 of the plate spring 30A, which has the through-holes 31a, 32a and is joined to and is fixed to the plate spring segment 21 by the bolts 50a, 50b, serves as a primary fixing portion.

Here, a plurality (two in this embodiment) of spacers 60a, 60b are arranged between the plate spring 30A and the plate spring segment 21 of the coupling plate spring 20. The spacer 60a has a through-hole to receive the bolt 50a. The spacer 60b has a through-hole to receive the bolt 50b.

Therefore, a gap is formed between the one longitudinal side of the plate spring segment 21 and the plate spring 30A. An intervening portion of the plate spring 30A, which is located between the fixing portion 36 of the plate spring 30A (i.e., the fixing portion 36 having the through-holes 31a, 32a shown in FIG. 5) and the frictional contact portion 33a, serves as a primary intervening portion and is spaced from the plate spring segment 21 by this gap.

The frictional contact portion 33a (i.e., a primary frictional contact portion), which contacts the frictional contact portion 21c of the plate spring segment 21 of the coupling plate spring 20, is formed at the other longitudinal side of the plate spring 30A. Furthermore, a flexed portion 34a, which forms a gap between the flexed portion 34a and the plate spring segment 21 of the coupling plate spring 20, is formed at an end portion of the plate spring 30A located on the other longitudinal side.

The plate spring 40A is a primary plate spring and is arranged such that the plate spring 40A overlaps the plate spring segment 21 in the X direction (i.e., the first direction). The plate spring 40A is located on the other side of the plate spring segment 21 in the thickness direction of the plate spring segment 21. The plate spring 40A is shaped in an elongated plate form such that a longitudinal direction of the plate spring 40A coincides with the Y direction. A thickness direction of the plate spring 40A coincides with the X direction, and a width direction of the plate spring 40A coincides with the Z direction. A plurality (two in this embodiment) of through-holes 41a, 42a are formed at one longitudinal side of the plate spring 40A to receive the bolts 50a, 50b, respectively. A fixing portion 46 of the plate spring 40A, which has the through-holes 41a, 42a and is joined to and is fixed to the plate spring segment 21 by the bolts 50a, 50b, serves as a primary fixing portion.

Here, a plurality (two in this embodiment) of spacers 60c, 60d are arranged between the plate spring 40A and the plate spring segment 21 of the coupling plate spring 20. The spacer 60c has a through-hole to receive the bolt 50a The spacer 60d has a through-hole to receive the bolt 50b.

Therefore, a gap is formed between the one longitudinal side of the plate spring segment 21 and the plate spring 40A. An intervening portion of the plate spring 40A, which is located between the fixing portion 46 of the plate spring 40A (i.e., the fixing portion 46 having the through-holes 41a, 42a) and the frictional contact portion 43a, serves as a primary intervening portion and is spaced from the plate spring segment 21 by this gap.

The frictional contact portion 43a (i.e., a primary frictional contact portion), which contacts the frictional contact portion 21c of the plate spring segment 21 of the coupling plate spring 20, is formed at the other longitudinal side of the plate spring 40A. Furthermore, a flexed portion 44a, which forms a gap between the flexed portion 44a and the plate spring segment 21 of the coupling plate spring 20, is formed at an end portion of the plate spring 40A located on the other longitudinal side.

The plate spring segment 22 is a second plate spring segment and is shaped in an elongated plate form such that a longitudinal direction of the plate spring segment 22 intersects the X direction and also intersects the Z direction. A thickness direction of the plate spring segment 22 coincides with the Y direction, and a width direction of the plate spring segment 22 intersects the Z direction and also intersects the X direction.

A plurality (two in this embodiment) of through-holes 22a, 22b are formed at one longitudinal side of the plate spring segment 22. The through-holes 22a, 22b are formed to receive bolts 51a, 51b, respectively. The plate spring segment 22 of the coupling plate spring 20 and the plate springs 30B, 40B are joined to and are fixed to the traveling engine 3 by the bolts 51a, 51b.

Therefore, the plate springs (serving as a pair of secondary plate springs) 30B, 40B are fixed to the plate spring segment 22 of the coupling plate spring 20. A frictional contact portion 22c, which contacts a frictional contact portion 33b of the plate spring 303 and a frictional contact portion 43b of the plate spring 40B, is formed at the other longitudinal side of the plate spring segment 22.

The plate spring 30B is a secondary plate spring and is arranged such that the plate spring 30B overlaps the plate spring segment 22 in the Y direction (i.e., a second direction). The plate spring 30B is located on one side of the plate spring segment 22 in the thickness direction of the plate spring segment 22. The plate spring 30B is shaped in an elongated plate form such that a longitudinal direction of the plate spring 30B intersects the Z direction and also intersects the X direction. A thickness direction of the plate spring 30B coincides with the Y direction, and a width direction of the plate spring 30B intersects the Z direction and also intersects the X direction.

A plurality (two in this embodiment) of through-holes 31b, 32b are formed at one longitudinal side of the plate spring 30B. The through-holes 31b, 32b are formed to receive the bolts 51a, 51b, respectively. A fixing portion 66 of the plate spring 30B, which has the through-holes 31b, 32b and is joined to and is fixed to the plate spring segment 22 by the bolts 51a, 51b, serves as a secondary fixing portion.

Here, a plurality (two in this embodiment) of spacers 61a, 61b are arranged between the plate spring 30B and the plate spring segment 22 of the coupling plate spring 20. The spacer 61a has a through-hole to receive the bolt 51a. The spacer 61b has a through-hole to receive the bolt 51b.

Therefore, a gap is formed between the one longitudinal side of the plate spring segment 22 and the plate spring 30B. An intervening portion of the plate spring 30B, which is located between the fixing portion 66 of the plate spring 308 (i.e., the fixing portion 66 having the through-holes 31b, 32b shown in FIG. 5) and the frictional contact portion 33b, serves as a secondary intervening portion and is spaced from the plate spring segment 22 by this gap.

The frictional contact portion 33b (i.e., a secondary frictional contact portion), which contacts the frictional contact portion 22c of the plate spring segment 22 of the coupling plate spring 20, is formed at the other longitudinal side of the plate spring 303. Furthermore, a flexed portion 34b, which forms a gap between the flexed portion 34b and the plate spring segment 22 of the coupling plate spring 20, is formed at an end portion of the plate spring 30B located on the other longitudinal side.

The plate spring 40B is a secondary plate spring and is arranged such that the plate spring 40B overlaps the plate spring segment 22 in the Y direction (i.e., the second direction). The plate spring 40B is located on the other side of the plate spring segment 22 in the thickness direction of the plate spring segment 22.

The plate spring 40B is shaped in an elongated plate form such that a longitudinal direction of the plate spring 403 intersects the Z direction and also intersects the X direction. A thickness direction of the plate spring 3DB coincides with the Y direction. A plurality (two in this embodiment) of through-holes 41b, 42b are formed at one longitudinal side of the plate spring 403. The through-holes 41b, 42b are formed to receive the bolts 51a, 51b, respectively. A fixing portion 76 of the plate spring 40B, which has the through-holes 41b, 42b and is joined to and is fixed to the plate spring segment 22 by the bolts 51a, 51b, serves as a secondary fixing portion.

Here, a plurality (two in this embodiment) of spacers 61c, 61d are arranged between the plate spring 40B and the plate spring segment 22 of the coupling plate spring 20. The spacer 61c has a through-hole to receive the bolt 51a, The spacer 61d has a through-hole to receive the bolt 51b.

Therefore, a gap is formed between the one longitudinal side of the plate spring segment 22 and the plate spring 403. An intervening portion of the plate spring 403, which is located between the fixing portion 76 of the plate spring 40B (i.e., the fixing portion 76 having the through-holes 41b, 42b shown in FIG. 5) and the frictional contact portion 43b, serves as a secondary intervening portion and is spaced from the plate spring segment 22 by this gap.

The frictional contact portion 43b (i.e., a secondary frictional contact portion), which contacts the frictional contact portion 22c of the plate spring segment 22 of the coupling plate spring 20, is formed at the other longitudinal side of the plate spring 40B. Furthermore, a flexed portion 44b, which forms a gap between the flexed portion 44b and the plate spring segment 22 of the coupling plate spring 20, is formed at an end portion of the plate spring 40B located on the other longitudinal side.

The plate spring segment 23 is a third plate spring segment and is shaped in an elongated plate form such that a longitudinal direction of the plate spring segment 23 intersects the X direction and also intersects the Y direction. A thickness direction of the plate spring segment 23 coincides with the Z direction, and a width direction of the plate spring segment 23 intersects the X direction and also intersects the Y direction. A plurality (two in this embodiment) of through-holes 23a, 23b are formed at one longitudinal side of the plate spring segment 23.

The through-holes 23a, 23b are formed to receive bolts 52a, 52b, respectively. The plate spring segment 23 of the coupling plate spring 20 is joined to and is fixed to the plate springs 30C, 40C by the bolts 52a, 52b. Therefore, the plate springs (serving as a pair of tertiary plate springs) 30C, 40C are fixed to the plate spring segment 23 of the coupling plate spring 20, A frictional contact portion 23c, which contacts a frictional contact portion 33c of the plate spring 30C and a frictional contact portion 43c of the plate spring 40C, is formed at the other longitudinal side of the plate spring segment 23.

The plate spring 30C is a tertiary plate spring and is arranged such that the plate spring 30C overlaps the plate spring segment 23 in the Z direction (i.e., a third direction). The plate spring 30C is located on one side of the plate spring segment 23 in the thickness direction of the plate spring segment 23.

The plate spring 30C is shaped in an elongated plate form such that a longitudinal direction of the plate spring 30C intersects the X direction and also intersects the Y direction. A thickness direction of the plate spring 30C coincides with the Z direction, and a width direction of the plate spring 30C intersects the X direction and also intersects the Y direction. A plurality (two in this embodiment) of through-holes 31c, 32c are formed at one longitudinal side of the plate spring 30C. The through-holes 31c, 32c are formed to receive the bolts 52a, 52b, respectively. A fixing portion 86 of the plate spring 30C, which has the through-holes 31c, 32c and is joined to and is fixed to the plate spring segment 23 by the bolts 52a, 52b, serves as a tertiary fixing portion.

Here, a plurality (two in this embodiment) of spacers 62a, 62b are arranged between the plate spring 30C and the plate spring segment 23 of the coupling plate spring 20. The spacer 62a has a through-hole to receive the bolt 52a, The spacer 62b has a through-hole to receive the bolt 52b.

Therefore, a gap is formed between the one longitudinal side of the plate spring segment 23 and the plate spring 30C. An intervening portion of the plate spring 30C, which is located between the fixing portion 86 of the plate spring 30C (i.e., the fixing portion 86 having the through-holes 31c, 32c shown in FIG. 5) and the frictional contact portion 33c, serves as a tertiary intervening portion and is spaced from the plate spring segment 23 by this gap.

The frictional contact portion 33c (i.e,, a tertiary frictional contact portion), which contacts the frictional contact portion 23c of the plate spring segment 23 of the coupling plate spring 20, is formed at the other longitudinal side of the plate spring 30C. Furthermore, a flexed portion 34c, which forms a gap between the flexed portion 34c and the plate spring segment 23 of the coupling plate spring 20, is formed at an end portion of the plate spring 30C located on the other longitudinal side.

The plate spring 40C is a tertiary plate spring and is arranged such that the plate spring 40C overlaps the plate spring segment 23 in the Z direction (i.e., the third direction). The plate spring 40C is located on the other side of the plate spring segment 23 in the thickness direction of the plate spring segment 23, The plate spring 40C is shaped in an elongated plate form such that a longitudinal direction of the plate spring 40C intersects the X direction and also intersects the Y direction.

A thickness direction of the plate spring 40C coincides with the Z direction, and a width direction of the plate spring 40C intersects the X direction and also intersects the Y direction. A plurality (two in this embodiment) of through-holes 41c, 42c are formed at one longitudinal side of the plate spring 40C. The through-holes 41c, 42c are formed to receive the bolts 52a, 52b, respectively. A fixing portion 96 of the plate spring 40C, which has the through-holes 41c, 42c and is joined to and is fixed to the plate spring segment 23 by the bolts 52a, 52b, serves as a tertiary fixing portion.

Here, a plurality (two in this embodiment) of spacers 62c, 62d are arranged between the plate spring 40C and the plate spring segment 23 of the coupling plate spring 20. The spacer 62c has a through-hole to receive the bolt 52a. The spacer 62d has a through-hole to receive the bolt 52b.

Therefore, a gap is formed between the one longitudinal side of the plate spring segment 23 and the plate spring 40C. An intervening portion of the plate spring 40C, which is located between the fixing portion 96 of the plate spring 40C (i.e., the fixing portion 96 having the through-holes 41c, 42c shown in FIG. 5) and the frictional contact portion 43c, serves as a tertiary intervening portion and is spaced from the plate spring segment 23 by this gap.

The frictional contact portion 43c (i.e., a tertiary frictional contact portion), which contacts the frictional contact portion 23c of the plate spring segment 23 of the coupling plate spring 20, is formed at the other longitudinal side of the plate spring 40C. Furthermore, a flexed portion 44c, which forms a gap between the flexed portion 44c and the plate spring segment 23 of the coupling plate spring 20, is formed at an end portion of the plate spring 40C located on the other longitudinal side.

A plurality (two in this embodiment) of through-holes 25a, 25b are formed at an end portion 24 of the plate spring segment 23 located on the other longitudinal side. The through-holes 25a, 25b are formed to receive the bolts 53a, 53b, respectively. The plate spring segment 23 of the coupling plate spring 20 is joined to and is fixed to a fixing portion 2a of the compressor 2 by the bolts 53a, 53b.

In the present embodiment, a bent portion (serving as a connecting portion) 26 is formed between the plate spring segments 21, 22 to connect therebetween. A bent portion (serving as a connecting portion) 27 is formed between the plate spring segments 21, 23 to connect therebetween.

Here, in the coupling plate spring 20, the plate spring segments 21, 22, 23 and the bent portions 26, 27 are formed integrally in one-piece as a one-piece product. The longitudinal directions of the plate spring segments 21, 22, 23 are different from each other. The thickness directions of the plate spring segments 21, 22, 23 are different from each other.

The end portion 24 and the bent portions 26, 27 of the coupling plate spring 20 respectively serve as a fourth plate spring segment that does not overlap any one of the plate springs 30A, 40A, 30B, 40B, 30C, 40C in the thickness direction thereof. A size in the width direction and a size in the thickness direction of each of the end portion 24 and the bent portions 26, 27 are larger than a size in the width direction and a size in the thickness direction of each of the other overlapping portions of the coupling plate spring 20, which respectively overlap the corresponding adjacent one of the plate springs 30A, 40A, 30B, 40B, 30C, 40C.

An extending direction of the coupling plate spring 20 between the compressor 2 and the traveling engine 3 is defined as a longitudinal direction of the coupling plate spring 20. A thickness direction of the coupling plate spring 20 is a direction that is perpendicular to the longitudinal direction of the coupling plate spring 20. A width direction of the coupling plate spring 20 is a direction that is perpendicular to the longitudinal direction of the coupling plate spring 20 and also perpendicular to the thickness direction of the coupling plate spring 20.

The spring units 10B, 10C, 10D are configured in the same manner as the spring unit 10A.

Next, the operation of the vehicular vibration isolator 1 of the present embodiment will be described.

First, when the compressor 2 starts the operation thereof, vibrations are generated from the compressor 2 and are conducted to the vehicular vibration isolator 1. These vibrations are conducted to the spring units 10A, 108, 10C, 10D.

At this time, the vibrations conducted to the spring unit 10A cause the frictional contact portion 33a of the plate spring 30A and the frictional contact portion 43a of the plate spring 40A to generate sliding friction relative to the frictional contact portion 21c of the plate spring segment 21 of the coupling plate spring 20. Therefore, among the vibrations conducted to the spring unit 10A, the vibration in the X direction can be attenuated.

Furthermore, the vibrations conducted to the spring unit 10A cause the frictional contact portion 33b of the plate spring 308 and the frictional contact portion 43b of the plate spring 408 to generate sliding friction relative to the frictional contact portion 22c of the plate spring segment 22 of the coupling plate spring 20. Therefore, among the vibrations conducted to the spring unit 10A, the vibration in the Y direction can be attenuated.

Furthermore, the vibrations conducted to the spring unit 10A cause the frictional contact portion 33c of the plate spring 30C and the frictional contact portion 43c of the plate spring 40C to generate sliding friction relative to the frictional contact portion 23c of the plate spring segment 23 of the coupling plate spring 20. Therefore, among the vibrations conducted to the spring unit 10A, the vibration in the Z direction can be attenuated.

As described above, the spring unit 10A can attenuate the vibration in the X direction, the vibration in the Y direction and the vibration in the Z direction among the vibrations conducted from the compressor 2 to the spring unit 10A.

Likewise, each of the spring units 108, 10C, 10D can attenuate the vibration in the X direction, the vibration in the Y direction and the vibration in the Z direction among the vibrations conducted from the compressor 2.

In this way, the conduction of the vibrations from the compressor 2 to the traveling engine 3 can be limited.

According to the present embodiment described above, the vehicular vibration isolator 1 can limit the conduction of the vibrations, which are generated at the compressor 2, to the traveling engine 3. The coupling plate spring 20 has the plate spring segments 21, 22, 23 and couples between the compressor 2 and the traveling engine 3 through the plate spring segments 21, 22, 23.

The plate springs 30A, 40A are arranged to overlap the plate spring segment 21 in the X direction and are supported by the plate spring segment 21. Furthermore, each of the plate springs 30A, 40A has the frictional contact portion 33a, 43a which is configured to generate the sliding friction relative to the frictional contact portion 21c of the plate spring segment 21 in response to the vibrations. Therefore, the vibration in the X direction can be attenuated among the vibrations conducted from the compressor 2 to the coupling plate spring 20. In addition, it is possible to attenuate the vibration in the θ direction, which is the swing direction about the axis extending in the X direction.

The plate springs 30B, 40B are arranged to overlap the plate spring segment 22 in the Y direction and are supported by the plate spring segment 22. Furthermore, each of the plate springs 30B, 40B has the frictional contact portion 33b, 43b which is configured to generate the sliding friction relative to the frictional contact portion 22c of the plate spring segment 22 in response to the vibrations. Therefore, it is possible to attenuate the vibration in the Y direction among the vibrations conducted from the compressor 2 to the coupling plate spring 20. In addition, it is possible to attenuate the vibration in the cp direction which is the swing direction about the axis extending in the Y direction.

The plate springs 30C, 40C are arranged to overlap the plate spring segment 23 in the Z direction and are supported by the plate spring segment 23. Furthermore, each of the plate springs 30C, 40C has the frictional contact portion 33c, 43c which is configured to generate the sliding friction relative to the frictional contact portion 23c of the plate spring segment 23 in response to the vibrations. Therefore, the vibration in the Z direction can be attenuated among the vibrations conducted from the compressor 2 to the coupling plate spring 20, In addition, it is possible to attenuate the vibration in the ψ direction, which is the swing direction about the axis extending in the Z direction.

Accordingly, it is possible to attenuate the vibration in the X direction, the vibration in the Y direction, the vibration in the Z direction, the vibration in the θ direction, the vibration in the φ direction and the vibration in the P direction among the vibrations conducted from the compressor 2. Thus, it is possible to limit the conduction of the vibrations from the compressor 2 to the traveling engine 3.

Here, a line Za of a graph of FIG. 8 indicates a frequency characteristic of a transfer function of the vibration conducted from the compressor 2 to the traveling engine 3 in a case where the vehicular vibration isolator 1 is not provided. Furthermore, a line Zb of the graph of FIG. 8 indicates a frequency characteristic of a transfer function of the vibration conducted from the compressor 2 to the traveling engine 3 in a case where the vehicular vibration isolator 1 is provided.

The vehicular vibration isolator 1 can improve the vibration isolating effect at a frequency that is equal to or higher than a resonance frequency of 32 Hz which is determined in view of the compressor 2 and the vehicular vibration isolator 1. Therefore, it is desirable that the resonance frequency is set in the low frequency range in order to improve the vibration isolating effect.

In contrast, in a case where the resonance frequency is in the low frequency range, peaks P1, P2 appear in the low frequency range in a case where the vibrations are conducted from the compressor 2 to the traveling engine 3 through the vehicular vibration isolator 1 and are then conversely conducted from the traveling engine 3 to the compressor 2 through the vehicular vibration isolator 1.

Therefore, a displacement of the vehicular vibration isolator 1 and a displacement of the compressor 2 become large due to the vibrations. Accordingly, the durability of the compressor 2 and the durability of the vehicular vibration isolator 1 are deteriorated. Further, the compressor 2 and the vehicular vibration isolator 1 interfere with other components of the vehicle arranged around the compressor 2 and the vehicular vibration isolator 1.

Therefore, it is necessary to contain the resonance frequencies within a range that can satisfy both a required degree of vibration isolation and a required degree of durability. Furthermore, although the vibration isolating effect at the resonance frequencies in the above-described range may possibly deteriorate due to the containment of the resonance frequencies in the above-described range, the attenuation of the vibrations by the sliding frictions of the vehicular vibration isolator 1 of the present embodiment can limit the vibrations.

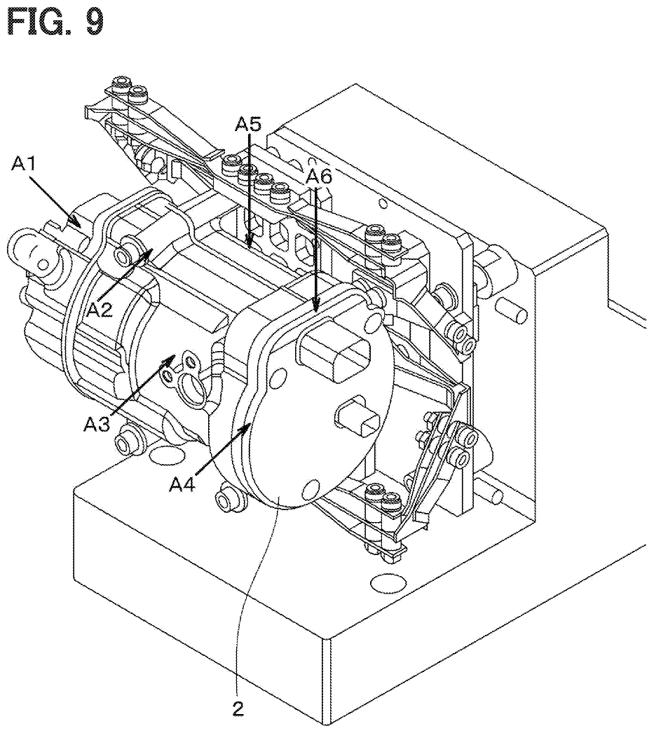

Next, with reference to FIGS. 9 to 11, there will be described attenuation of the vibrations as a result of a vibration test of the present embodiment, in which the vibrations are applied to the compressor 2 by a hammer.

In FIG. 9, an arrow A1 is a vibrating direction for vibrating with the hammer in the X direction at the compressor 2, and an arrow A2 is a vibration excitation point where the vibration in the X direction is excited by the hammer at the compressor 2. An arrow A3 is a vibration excitation point where the vibration in the Y direction is excited by the hammer at the compressor 2, and an arrow A4 is a vibrating direction for vibrating by the hammer in the Y direction at the compressor 2. An arrow A5 is a vibration excitation point where the vibration in the Z direction is excited by the hammer at the compressor 2, and an arrow A6 is a vibrating direction for vibrating with the hammer in the Z direction at the compressor 2.

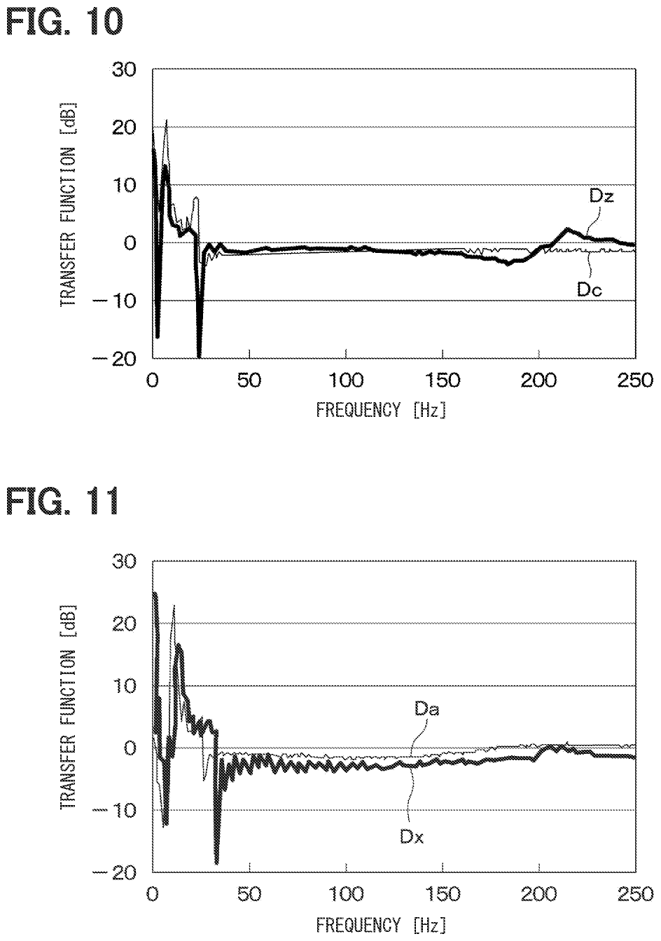

In FIG. 10, a line Dz indicates a transfer function in a case where the laminated spring, which generates sliding friction in the Z direction, is used, and a line Dc indicates a transfer function in a case where the laminated spring, which generates the sliding friction in the Z direction, is not used. As understood from the line Dz and the line Dc in FIG. 10, the vibration in the Z direction can be attenuated by the laminated spring.

In FIG. 11, a line Dx indicates a transfer function in a case where the laminated spring, which generates sliding friction in the X direction, is used, and a line Da indicates a transfer function in a case where the laminated spring, which generates the sliding friction in the X direction, is not used.

As understood from the line Dx and the line Da in FIG. 11, the vibration in the X direction can be attenuated by the laminated spring.

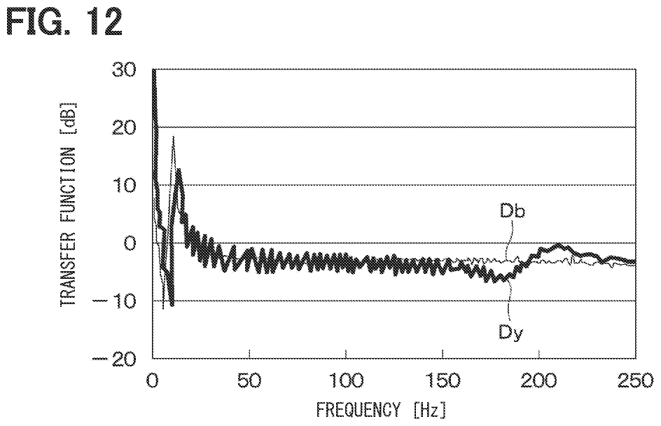

In FIG. 12, a line Dy indicates a transfer function in a case where the laminated spring, which generates sliding friction in the Y direction, is used, and a line Db indicates a transfer function in a case where the laminated spring, which generates the sliding friction in the Y direction, is not used. As understood from the line Dy and the line Db in FIG. 12, the vibration in the Y direction can be attenuated by the laminated spring.

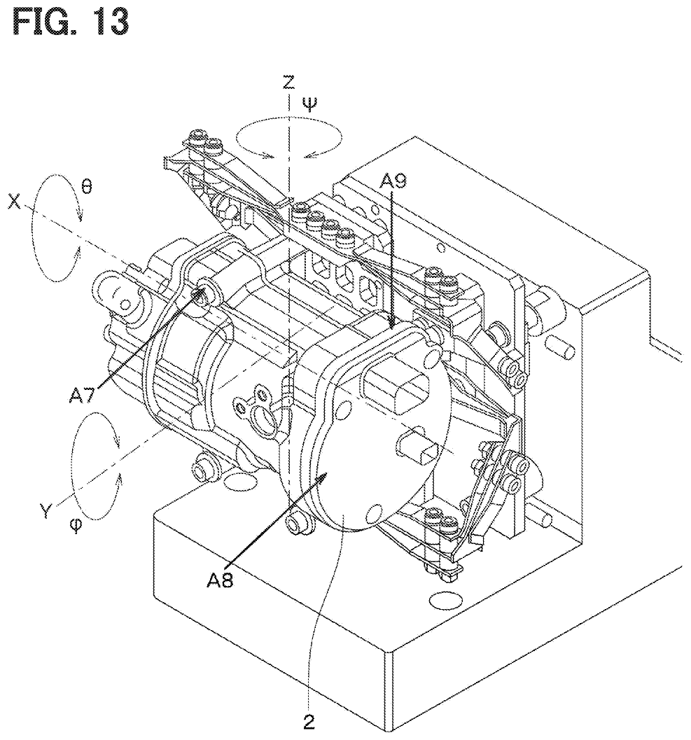

In FIG. 13, an arrow A7 is a vibration excitation point where the vibration in the 8 direction is excited by the hammer at the compressor 2, and an arrow A8 is a vibration excitation point where the vibration in the φ direction is excited by the hammer at the compressor 2. Also, in FIG. 13, an arrow A9 is a vibration excitation point where the vibration in the ψ direction is excited by the hammer at the compressor 2.

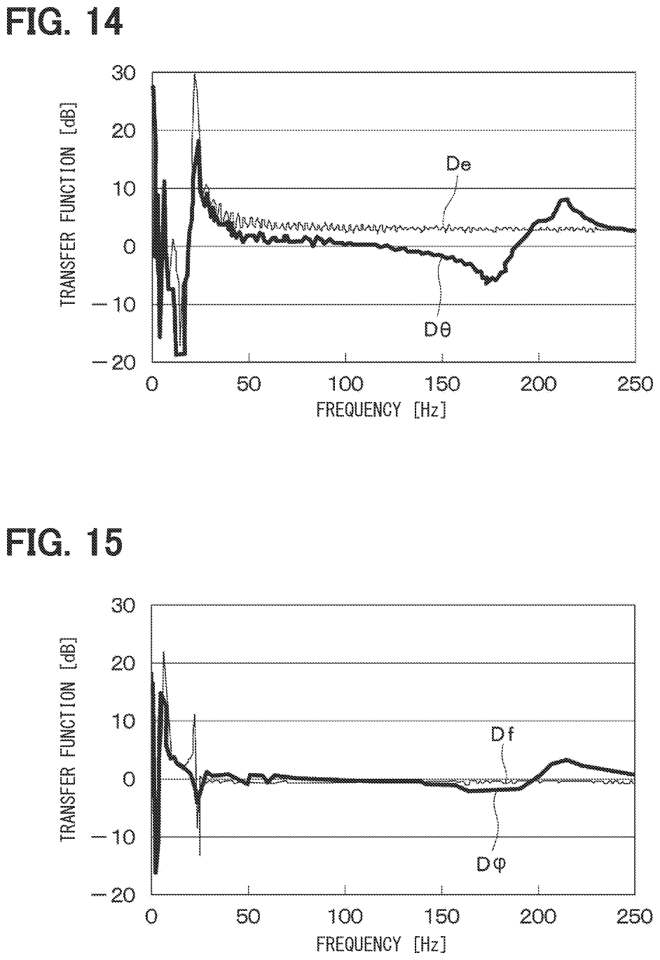

In FIG. 14. a line D8 indicates a transfer function in a case where the laminated spring, which generates sliding friction in the θ direction, is used, and a line De indicates a transfer function in a case where the laminated spring, which generates the sliding friction in the θ direction, is not used.

As understood from the line Dθ and the line De in FIG. 14, the vibration in the 8 direction can be attenuated by the laminated spring. In FIG. 15, a line D_{T} indicates a transfer function in a case where the laminated spring, which generates sliding friction in the φ direction, is used, and a line Df indicates a transfer function in a case where the laminated spring, which generates the sliding friction in the φ direction, is not used. As understood from the line DT and the line Df in FIG. 15, the vibration in the φ direction can be attenuated by the laminated spring,

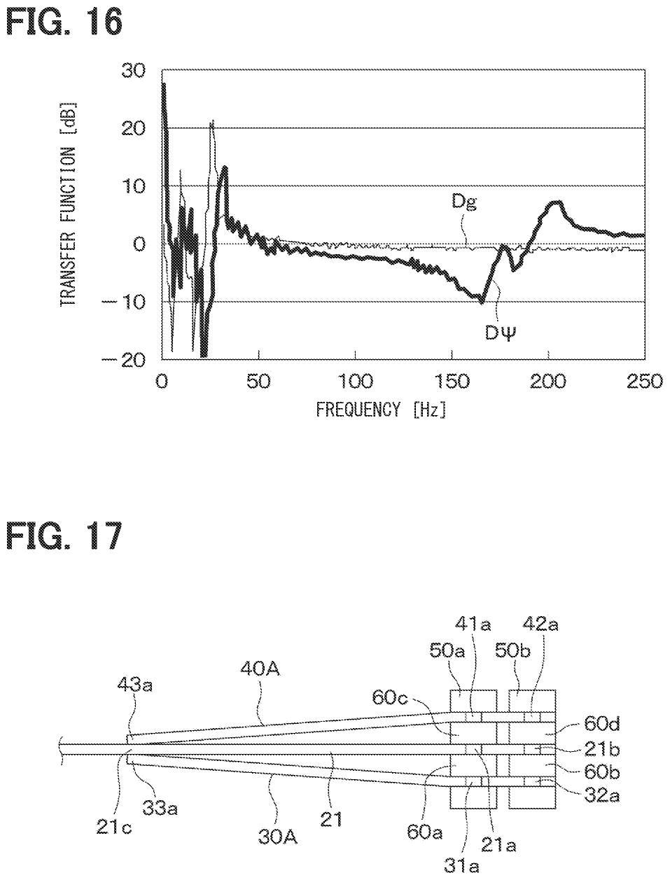

In FIG. 16, a line Dψ indicates a transfer function in a case where the laminated spring, which generates sliding friction in the ψ direction, is used, and a line Dg indicates a transfer function in a case where the laminated spring, which generates the sliding friction in the ψ direction, is not used. As understood from the line Dψ and the line Dg in FIG. 16, the vibration in the ψ direction can be attenuated by the laminated spring.

### Modification of First Embodiment

In the first embodiment, there is described the example where the flexed portions 34a, 44a are formed at the end portions, respectively, of the plate springs 30A, 40A located on the other longitudinal side in the spring unit 10A. Alternatively, as shown in FIG. 17, the flexed portions 34a, 44a may be eliminated at the end portions, respectively, of the plate springs 30A, 40A located on the other longitudinal side of the plate springs 30A, 40A in the spring unit 10A,

Furthermore, the other plate springs 30B, 40B, 30C, 40C may be formed in the same manner as that of the plate springs 30A, 40A described above with reference to FIG. 17.

### Second Embodiment

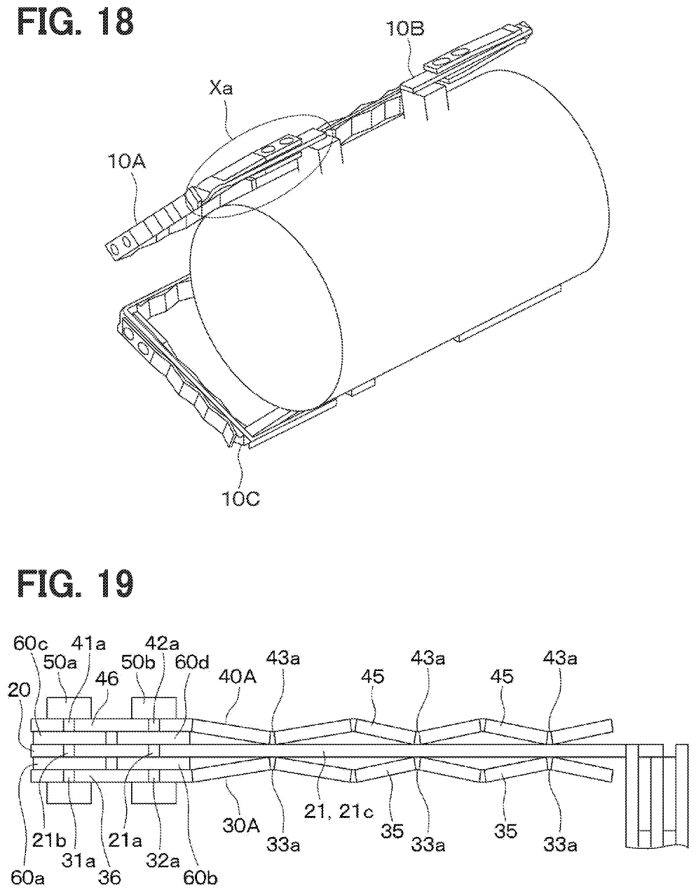

In the first embodiment, there is described the example where the plate spring 30A has the single frictional contact portion 33a which contacts the coupling plate spring 20. Alternatively, with reference to FIGS. 18 and 19, there will be described a second embodiment (a modification of the first embodiment), in which the plate spring 30A has a plurality of frictional contact portions 33a that contact the coupling plate spring 20.

FIG. 18 is a view showing an overall structure of the vehicular vibration isolator 1 of the present embodiment, and FIG. 19 is a partial enlarged view of an area Xa of the spring unit 10A shown in FIG. 18. In FIGS. 18 and 19, the portions, which are the same as those of FIGS, 1, 2 and 5, are indicated by the same references signs as those of FIGS. 1, 2 and 5, and redundant description thereof will be omitted for the sake of simplicity.

In the spring unit 10A of the present embodiment, the plurality of frictional contact portions 33a, which contact the frictional contact portion 21c of the plate spring segment 21 of the coupling plate spring 20, are formed at a portion of the plate spring 30A which is other than the fixing portion 36. The fixing portion 36 of the plate spring 30A is joined to and is fixed to the coupling plate spring 20 by the bolts 50a, 50b.

The plate spring 30A has a plurality of non-contact portions 35, each of which is in a non-contact state where the non-contact portion 35 does not contact the frictional contact portion 21c of the plate spring segment 21 of the coupling plate spring 20. The frictional contact portions 33a and the non-contact portions 35 are alternately arranged along the plate spring 30A.

In the spring unit 10A, a plurality of frictional contact portions 43a, which contact the frictional contact portion 21c of the plate spring segment 21 of the coupling plate spring 20, are formed at a portion of the plate spring 40A which is other than the fixing portion 46. The fixing portion 46 of the plate spring 40A is joined to and is fixed to the coupling plate spring 20 by the bolts 50a, 50b.

The plate spring 40A has a plurality of non-contact portions 45, each of which is in a non-contact state where the non-contact portion 45 does not contact the frictional contact portion 21c of the plate spring segment 21 of the coupling plate spring 20. The frictional contact portions 43a and the non-contact portions 45 are alternately arranged along the plate spring 40A. The spring unit 10B is also configured in the same manner as the spring unit 10A.

According to the present embodiment described above, in the spring unit 10A, the plate spring 30A has the frictional contact portions 33a which contact the frictional contact portion 21c of the plate spring segment 21 of the coupling plate spring 20. The plate spring 40A has the frictional contact portions 43a which contact the frictional contact portion 21c of the plate spring segment 21 of the coupling plate spring 20.

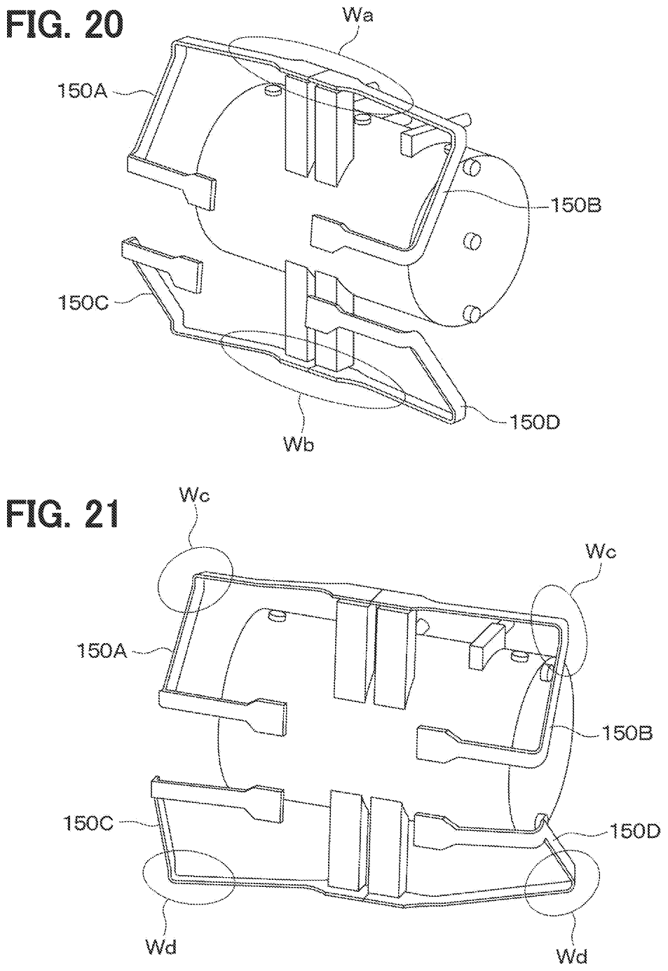

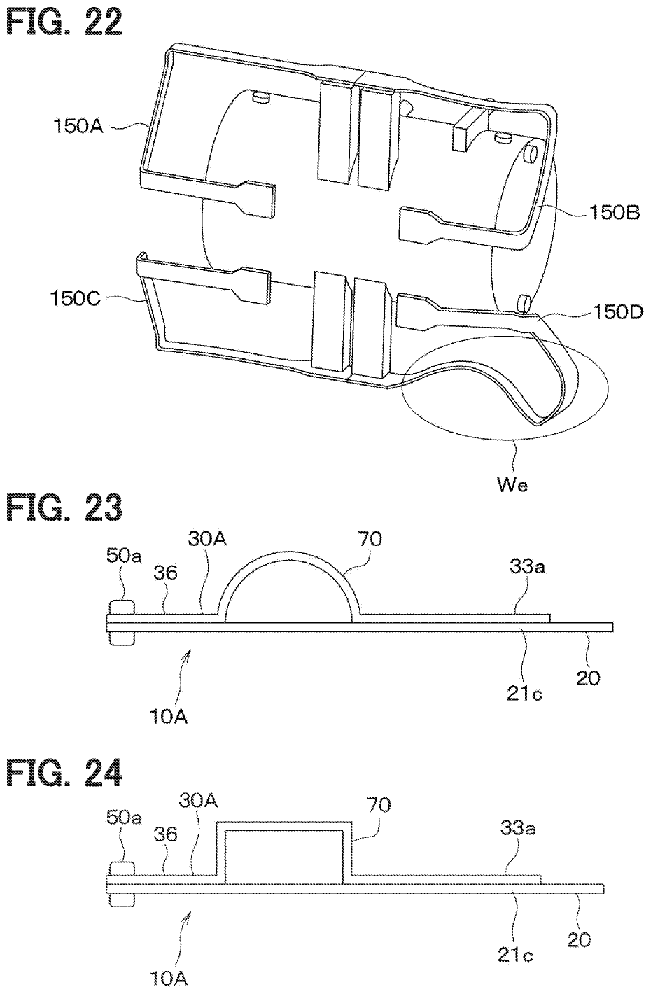

Here, FIGS. 20, 21 and 22 show states, in which spring units 150A, 150B, 150C, 150D coupled between the compressor 2 and the traveling engine 3 vibrate at different frequencies. Portions Wa, Wb of FIG. 20, portions Wc, Wd of FIG. 21 and a portion We of FIG. 22 are portions that are largely vibrated.

As can be seen from FIGS. 20, 21 and 22, it is understood that the spring units 150A, 150B, 156C, 150D have different vibration modes depending on the vibration frequency. At different vibration frequencies, different portions of the spring units 150A, 150B, 150C, 150D are largely displaced, i.e., largely moved.

In contrast, in the present embodiment, as described above, each of the plate springs 30A, 40A has the plurality of frictional contact portions 33a, 43a that contact the frictional contact portion 21c of the plate spring segment 21 of the coupling plate spring 20. Therefore, the plate springs 30A, 40A can generate the sliding friction at different frequencies, respectively. Therefore, the plate springs 30A, 40A can attenuate the vibrations at a plurality of frequencies,

### Third Embodiment

In a third embodiment (a modification of the first embodiment), with reference to FIG. 23, there will be described an example where the plate spring 30A of the spring unit 10A in the first embodiment is displaced, i.e., is moved (is slid) back and forth in the longitudinal direction relative to the coupling plate spring 20 in response to the vibrations, In the plate spring 30A of the present embodiment, the longitudinal direction of the plate spring 30A coincides with the longitudinal direction of the coupling plate spring 20 like in the first embodiment. The thickness direction of the plate spring 30A coincides with the thickness direction of the coupling plate spring 20. The width direction of the plate spring 30A coincides with the width direction of the coupling plate spring 20. The plate spring 30A is arranged such that the plate spring 30A overlaps the coupling plate spring 20 in the thickness direction.

The fixing portion 36, which is located at the one longitudinal side of the plate spring 30A, is joined to and is fixed to the coupling plate spring 20 by the bolt 50a, The other longitudinal side of the plate spring 30A forms the frictional contact portion 33a which contacts the frictional contact portion 21c of the plate spring segment 21 of the coupling plate spring 20. A displacement enabling portion 70 is formed at a longitudinal intermediate portion of the plate spring 30A (i.e., the intervening portion located between the fixing portion 36 and the frictional contact portion 33a at the plate spring 30A).

The displacement enabling portion 70 is shaped in a semicircular form (an arcuate form) and is spaced away from the coupling plate spring 20 by a gap. The displacement enabling portion 70 is configured to be resiliently deformed in the longitudinal direction in response to the vibrations. The displacement enabling portion 70 is formed to be spaced from the plate spring segment 21 of the coupling plate spring 20 by the gap.

In the present embodiment, when the vibrations are conducted from the compressor 2 to the spring unit 10A, the frictional contact portion 33a of the plate spring 30A generates the sliding friction relative to the frictional contact portion 21c of the plate spring segment 21 of the coupling plate spring 20. Therefore, among the vibrations conducted to the spring unit 10A, the vibration in the X direction can be attenuated.

At this time, the displacement enabling portion 70 is resiliently deformed by the vibration conducted to the plate spring 30A, so that the frictional contact portion 33a can be displaced, i.e., moved back and forth relative to the frictional contact portion 21c of the plate spring segment 21 of the coupling plate spring 20 in the longitudinal direction.

Here, although wear particles are generated by the sliding friction between the frictional contact portion 33a and the plate spring segment 21 of the coupling plate spring 20, the displacement enabling portion 70 is resiliently deformed to displace the frictional contact portion 33a back and forth relative to the frictional contact portion 21c of the plate spring segment 21 of the coupling plate spring 20 in the longitudinal direction. Therefore, the wear particles can be expelled from the location between the frictional contact portion 33a and the plate spring segment 21 of the coupling plate spring 20.

Thus, it is possible to limit occurrence of damage of the frictional contact portions 33a, 21c caused by the wear particles. As a result, it is possible to limit acceleration of the wearing of the frictional contact portions 33a, 21c.

Like the plate spring 30A, each of the plate springs 30B, 30C has the displacement enabling portion 70 that is configured to displace the frictional contact portion 33b, 33c.

### Modifications of Third Embodiment

In the third embodiment, there is described the example where the displacement enabling portion 70, which is shaped in the semicircular form, is formed at the plate spring 30A. This configuration may be modified to any one of (a), (b), (c) and (d) described below.

(a) As shown in FIG. 24, the displacement enabling portion 70, which is shaped in a rectangular form, may be formed at the plate spring 30A.

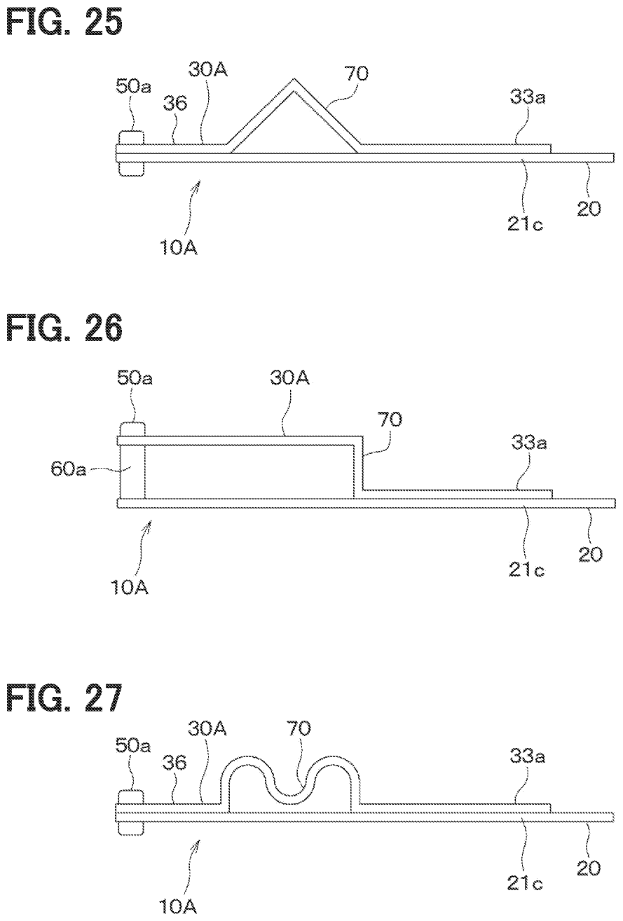

(b) As shown in FIG. 25, the displacement enabling portion 70, which is shaped in a triangular form, may be formed at the plate spring 30A.

(c) As shown in FIG. 26, the displacement enabling portion 70, which is shaped in a rectangular form, may be formed to extend from the frictional contact portion 33a to the bolt 50a along the plate spring 30A. In this case, one longitudinal side of the displacement enabling portion 70 of the plate spring 30A is joined to and is fixed to the coupling plate spring 20 by the bolt 50a.

The spacer 60a, through which the bolt 50a is inserted, is installed between the one longitudinal side of the displacement enabling portion 70 of the plate spring 30A and the coupling plate spring 20. Therefore, the displacement enabling portion 70 is arranged such that a gap is formed between the frictional contact portion 33a and the bolt 50a.

(d) As shown in FIG. 27, the displacement enabling portion 70, which is shaped in a form having two semicircular arches (two arcuate portions) connected one after another, may be formed at the plate spring 30A.

### Fourth Embodiment

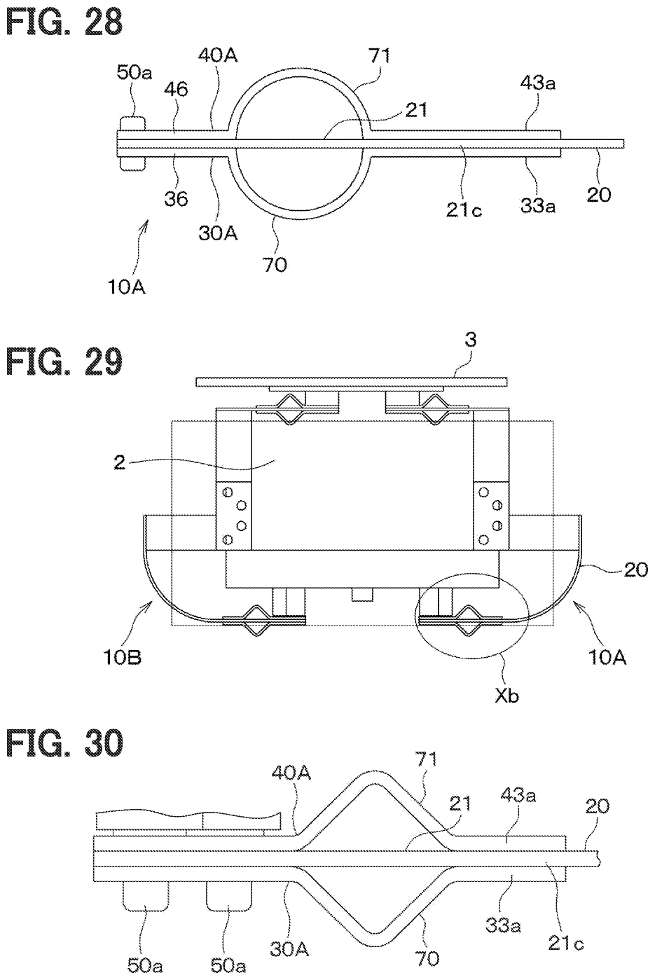

In the third embodiment, there is described the example where the displacement enabling portion 70, which is shaped in the arcuate form, is formed at the longitudinal center portion (longitudinal intermediate portion) of the plate spring 30A in the spring unit 10A. In a fourth embodiment (a modification of the third embodiment), as shown in FIG. 28, in addition to this plate spring 30A, the spring unit 10A has the plate spring 40A that has a displacement enabling portion 71, which is shaped in an arcuate form and is formed at a longitudinal intermediate portion of the plate spring 40A (i.e., the intervening portion located between the fixing portion 46 and the frictional contact portion 43a at the plate spring 40A).

In FIG. 28, the portions, which are the same as those of FIG. 23, are indicated by the same references signs as those of FIG. 23, and redundant description thereof will be omitted for the sake of simplicity.

In the spring unit 10A of the present embodiment, the displacement enabling portion 70 of the plate spring 30A and the displacement enabling portion 71 of the plate spring 40A are opposed to each other while the plate spring segment 21 of the coupling plate spring 20 is interposed between the displacement enabling portion 70 of the plate spring 30A and the displacement enabling portion 71 of the plate spring 40A. The displacement enabling portion 70 of the plate spring 30A and the displacement enabling portion 71 of the plate spring 40A are respectively shaped in the semicircular form (the arcuate form).

The other longitudinal side of the plate spring 40A of the present embodiment, which is located on the other longitudinal side of the displacement enabling portion 71, has the frictional contact portion 43a which contacts the plate spring segment 21 of the coupling plate spring 20. The fixing portion 46 of the plate spring 40A, which is located on the one longitudinal side of the displacement enabling portion 71, the plate spring segment 21 of the coupling plate spring 20 and the fixing portion 36 of the plate spring 30A, which is located on the one longitudinal side of the displacement enabling portion 70, are fixed together by the bolt 50a.

In the present embodiment configured in the above-described manner, the vibrations are conducted from the compressor 2 to the spring unit 10A. The vibrations conducted to the spring unit 10A cause the frictional contact portion 33a of the plate spring 30A and the frictional contact portion 43a of the plate spring 40A to generate the sliding friction relative to the frictional contact portion 21c of the plate spring segment 21 of the coupling plate spring 20. Therefore, among the vibrations conducted to the spring unit 10A, the vibration in the X direction can be attenuated.

At this time, the wear particles are generated by the sliding friction between each of the frictional contact portions 33a, 43a of the plate springs 30A, 40A and the frictional contact portion 21c of the plate spring segment 21 of the coupling plate spring 20.

The displacement enabling portion 70 is resiliently deformed in response to the vibrations conducted from the compressor 2 to the plate spring 30A of the spring unit 10A, so that the frictional contact portion 33a is displaced, Le., is moved (is slid) back and forth relative to the frictional contact portion 21c of the plate spring segment 21 of the coupling plate spring 20 in the longitudinal direction. Therefore, the wear particles can be expelled from the location between the frictional contact portion 33a and the frictional contact portion 21c.

The displacement enabling portion 71 is resiliently deformed in response to the vibrations conducted from the compressor 2 to the plate spring 40A, so that the frictional contact portion 43a is displaced, i.e., is moved (is slid) back and forth relative to the frictional contact portion 21c of the plate spring segment 21 of the coupling plate spring 20 in the longitudinal direction. Therefore, the wear particles can be expelled from the location between the frictional contact portion 43a and the frictional contact portion 21c.

Thus, it is possible to limit occurrence of damage of the frictional contact portions 33a, 43a, 21c caused by the wear particles. As a result, it is possible to limit acceleration of the wearing of the frictional contact portions 33a, 43a, 21c.

Furthermore, like the plate spring 40A, each of the plate springs 40B, 40C has the displacement enabling portion 71 that is configured to displace, i.e., move the frictional contact portion 43b, 43c.

### Modifications of Fourth Embodiment

In the fourth embodiment, there is described the example where the displacement enabling portion 70, 71, which is shaped in the semicircular form, is formed at each of the plate springs 30A, 40A in the spring unit 10k This configuration may be modified to any one of (a), (b), (c) and (d) described below.

(a) As shown in FIGS. 29, 30, in the spring units 10A, 10B, each of the plate springs 30A, 40A may have a displacement enabling portions 70, 71 that is shaped in a triangular form. FIG. 30 is a partial enlarged view of the spring unit 10A at an area Xb in FIG. 29.

In this case, like the fourth embodiment, the displacement enabling portion 70, 71 is resiliently deformed by the vibration, so that the frictional contact portions 33a, 43a is displaced, i.e., is moved back and forth relative to the frictional contact portion 21c of the plate spring segment 21 of the coupling plate spring 20 in the longitudinal direction. Therefore, the wear particles can be expelled from the location between the frictional contact portion 33a, 43a and the frictional contact portion 21c.

In this case, the plate spring segment 21 of the coupling plate spring 20 and the plate springs 30A, 40A are joined to and are fixed to the fixing portion 2a of the compressor 2 by two bolts 50a.

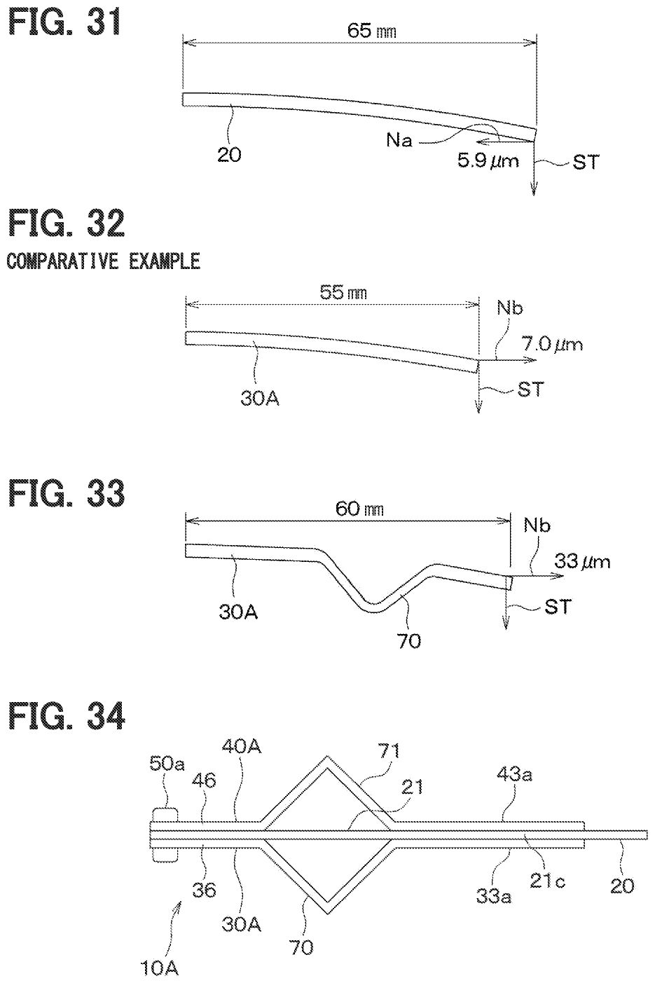

Next, a mechanism of displacing, i.e., moving (sliding) the frictional contact portions 33a, 43a in the longitudinal direction at the spring unit 10A will be described with reference to FIGS. 31, 32 and 33.

FIGS. 31, 32 and 33 show results of an experiment for forcefully displacing the spring unit 10A by 250 μm in a downward direction ST. FIG. 31 indicates a case where the coupling plate spring 20, which has a longitudinal length of 65 mm, is forcefully displaced by 250 μm in the downward direction ST, FIG. 32 indicates a case where the plate spring 30A, which has a longitudinal length of 55 mm and does not have the displacement enabling portion 70, is forcefully displaced by 250 μm in the downward direction ST. FIG. 33 indicates a case where the plate spring 30A, which has a longitudinal length of 60 mm and has the displacement enabling portion 70, is forcefully displaced by 250 μm in the downward direction ST.

As shown in FIG. 31, in the case where the coupling plate spring 20 is forcefully displaced by 250 μm in the downward direction ST, a lower surface of the coupling plate spring 20 is displaced by 5.9 μm toward the other longitudinal side Na.

As shown in FIG. 32, in the case where the plate spring 30A is forcefully displaced by 250 μm in the downward direction ST, an upper surface of the plate spring 30A is displaced by 7.0 μm toward the one longitudinal side Nb. In this case, the plate spring 30A is slid and is displaced by 13 μm relative to the coupling plate spring 20.

As shown in FIG. 33, in the case where the plate spring 30A is forcefully displaced by 250 μm in the downward direction ST, an upper surface of the plate spring 30A is displaced by 33 μm toward the one longitudinal side Nb. In this case, the plate spring 30A is slid and is displaced by 39 μm relative to the coupling plate spring 20.

It is understood that by providing the displacement enabling portion 70 at the plate spring 30A, the amount of slide displacement of the plate spring 30A relative to the coupling plate spring 20 is increased.

(b) As shown in FIG. 34, the plate spring segment 21 of the coupling plate spring 20 and the plate springs 30A, 40A may be fixed together by the single bolt 50a.

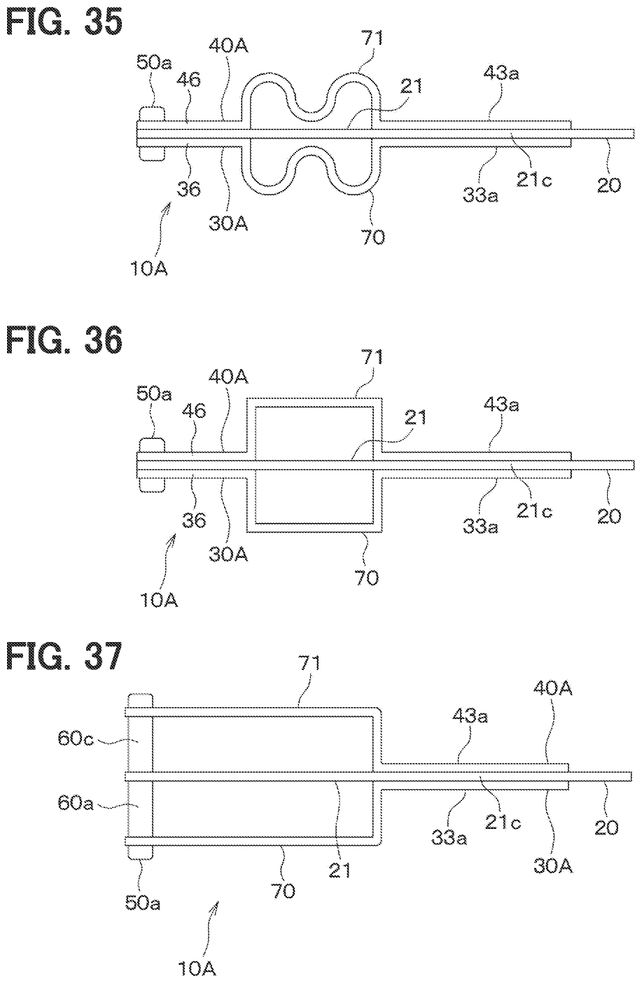

(c) As shown in FIG. 35, the displacement enabling portion 70, 71, which is shaped in a form having two semicircular arches (two arcuate portions) connected one after another, may be formed at each of the plate springs 30A, 40A.

(d) As shown in FIG. 36, the displacement enabling portion 70, 71, which is shaped in a rectangular form, may be formed at each of the plate springs 30A, 40A.

(e) As shown in FIG. 37, the displacement enabling portion 70, 71, which is shaped in a rectangular form, may be formed to extend from the frictional contact portion 33a, 43a to the bolt 50a along the plate spring 30A, 40A.

In this case, the spacer 60a is arranged between the plate spring 30A and the coupling plate spring 20. Also, the spacer 60c is arranged between the plate spring 40A and the coupling plate spring 20.

The bolt 50a extends through the through-holes of the plate springs 30A, 40A, the through-hole of the coupling plate spring 20 and the through-holes of the spacers 60a, 60c and fixes the plate springs 30A, 40A and the coupling plate spring 20 together.

### Fifth Embodiment

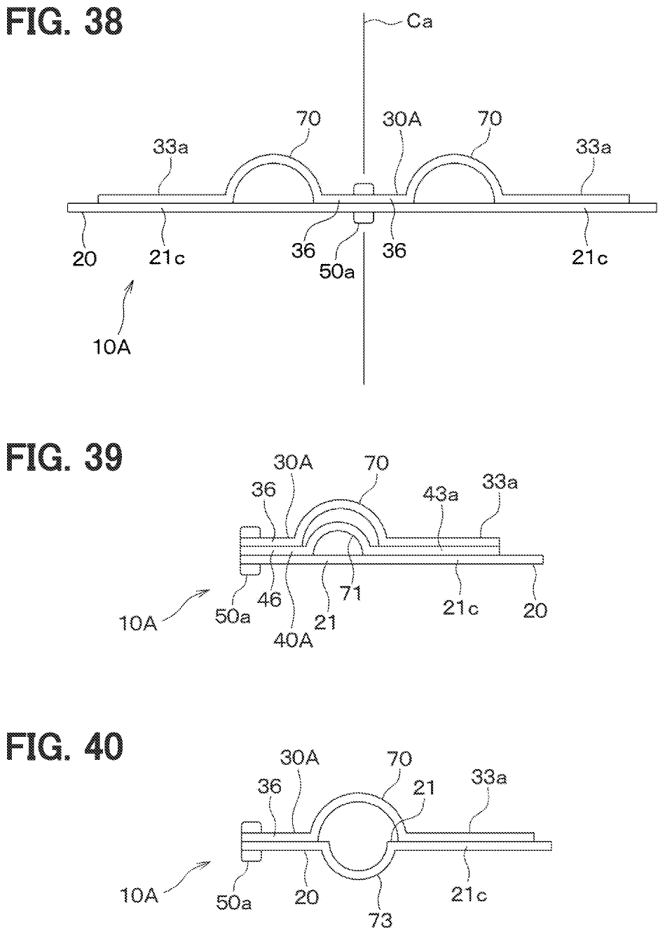

In the third embodiment, there is described the example where the plate spring 30A has the single frictional contact portion 33a and the single displacement enabling portion 70 in the spring unit 10A. Alternative to this configuration, with reference to FIG. 38, there will be described a fifth embodiment (a modification of the third embodiment), in which the plate spring 30A has two frictional contact portions 33a and two displacement enabling portions 70 in the spring unit 10A.

FIG. 38 is a side view showing a portion of the spring unit 10A of the present embodiment.

In the spring unit 10A, a longitudinal center portion of the plate spring 30A and the coupling plate spring 20 are fixed together by the bolt 50a.

The two frictional contact portions 33a are arranged to be plane-symmetrical about an imaginary plane Ca that includes a central axis of the bolt 50a. The imaginary plane Ca is a plane that is perpendicular to the longitudinal direction of the plate spring 30A and also perpendicular to the longitudinal direction of the coupling plate spring 20. The two displacement enabling portions 70 are arranged to be plane-symmetrical about the imaginary plane Ca. The coupling plate spring 20 has two frictional contact portions 21c which contact the two frictional contact portions 33a, respectively.

In the present embodiment, when the vibrations are conducted from the compressor 2 to the spring unit 10A, each of the two displacement enabling portions 70 is resiliently deformed.

At this time, one of the two displacement enabling portions 70, which is located on the right side in FIG. 38, displaces, i.e., moves the corresponding one of the two frictional contact portions 33a, which is located on the right side in FIG. 38, in the longitudinal direction. Also, the other one of the two displacement enabling portions 70, which is located on the left side in FIG. 38, displaces, i.e., moves the corresponding one of the two frictional contact portions 33a, which is located on the left side in FIG. 38, in the longitudinal direction.

Therefore, the wear particles can be expelled from the locations, each which is between the corresponding one of the two frictional contact portions 33a and the corresponding one of the two frictional contact portions 21c of the plate spring segment 21 of the coupling plate spring 20. Thus, it is possible to limit occurrence of damage of each of the two frictional contact portions 33a and the two frictional contact portions 21c of the plate spring segment 21 of the coupling plate spring 20 caused by the wear particles. As a result, it is possible to limit acceleration of the wearing of the two frictional contact portions 33a and the two frictional contact portions 21c.

### Sixth Embodiment

In the fourth embodiment, there is described the example where the coupling plate spring 20 is located between the plate springs 30A, 40A in the spring unit 10A. Alternatively, with reference to FIG. 39. there will be described a sixth embodiment (a modification of the fourth embodiment), in which the plate springs 30A, 40A are located on one side of the coupling plate spring 20 in the thickness direction of the coupling plate spring 20.

FIG. 39 is a side view showing a portion of the spring unit 10A of the present embodiment.

In the spring unit 10A, the displacement enabling portion 71 of the plate spring 40A is smaller than the displacement enabling portion 70 of the plate spring 30A. The displacement enabling portion 71 of the plate spring 40A is located on the inner side of the displacement enabling portion 70 of the plate spring 30A in the thickness direction of the coupling plate spring 20.

The frictional contact portion 33a, which contacts the frictional contact portion 43a of the plate spring 40A, is located on the other longitudinal side of the displacement enabling portion 70 at the plate spring 30A. The frictional contact portion 43a, which contacts the frictional contact portion 21c of the plate spring segment 21 of the coupling plate spring 20, is located on the other longitudinal side of the displacement enabling portion 71 at the plate spring 40A.

In the present embodiment, when the vibrations are conducted from the compressor 2 to the spring unit 10A, the frictional contact portion 33a of the plate spring 30A generates the sliding friction relative to the frictional contact portion 43a of the plate spring 40B. Therefore, among the vibrations conducted from the compressor 2 to the spring unit 10A, the vibration in the X direction can be attenuated by the sliding friction generated between the frictional contact portions 33a, 43a.

When the vibrations are conducted from the compressor 2 to the spring unit 10A, the frictional contact portion 43a of the plate spring 40A generates the sliding friction relative to the frictional contact portion 21c of the plate spring segment 21 of the coupling plate spring 20. Therefore, among the vibrations conducted from the compressor 2 to the spring unit 10A, the vibration in the X direction can be attenuated by the sliding friction generated between the frictional contact portions 43a, 21c.

Here, although wear particles are generated by the sliding friction between the frictional contact portions 33a, 43a of the plate springs 30A, 40A, the displacement enabling portion 70 is resiliently deformed to displace, i.e., move the frictional contact portion 33a back and forth relative to the frictional contact portion 43a in the longitudinal direction.

Therefore, the wear particles can be expelled from the location between the frictional contact portions 33a, 43a. Thus, it is possible to limit occurrence of damage of the frictional contact portions 33a, 43a caused by the wear particles. As a result, it is possible to limit acceleration of the wearing of the frictional contact portions 33a, 43a.

The displacement enabling portion 71 is resiliently deformed by the vibration conducted from the compressor 2 to the plate spring 40A, so that the frictional contact portion 43a is displaced, i.e., is moved back and forth relative to the frictional contact portion 21c in the longitudinal direction. Therefore, the wear particles can be expelled from the location between the frictional contact portions 43a, 21c. Thus, it is possible to limit occurrence of damage of the frictional contact portions 43a, 21c caused by the wear particles. As a result, it is possible to limit acceleration of the wearing of the frictional contact portions 43a, 21c.

### Seventh Embodiment

In a seventh embodiment (a modification of the third embodiment), with reference to FIG. 40, there will be described an example where a displacement enabling portion is added to the plate spring segment 21 of the coupling plate spring 20 in the third embodiment.

FIG. 40 is a side view showing a portion of the spring unit 10A of the present embodiment. In FIG. 40, the portions, which are the same as those of FIG. 23, are indicated by the same references signs as those of FIG. 23, and redundant description thereof will be omitted for the sake of simplicity.

A displacement enabling portion 73, which is shaped in a semicircular form (an arcuate form), is formed at the plate spring segment 21 of the coupling plate spring 20. The displacement enabling portion 73 is located on the one longitudinal side of the frictional contact portion 21c at the plate spring segment 21 of the coupling plate spring 20. The displacement enabling portion 73 is arranged such that the displacement enabling portion 73 overlaps the displacement enabling portion 70 of the plate spring 30A in the thickness direction of the coupling plate spring 20.

A shape of the displacement enabling portion 73 is different from the shape of the displacement enabling portion 70. Specifically, a radial size of the displacement enabling portion 73 is smaller than a radial size of the displacement enabling portion 70.

In the present embodiment configured in the above-described manner, the vibrations are conducted from the compressor 2 to the plate spring 30A through the coupling plate spring 20 at the spring unit 10A. At this time, the sliding friction is generated between the frictional contact portion 21c of the plate spring segment 21 of the coupling plate spring 20 and the frictional contact portion 33a of the plate spring 30A. Therefore, among the vibrations conducted to the spring unit 10A, the vibration in the X direction can be attenuated.

At this time, the displacement enabling portion 70 of the plate spring 30A is resiliently deformed to displace, i.e., move the frictional contact portion 33a in the longitudinal direction. Furthermore, the displacement enabling portion 73 is resiliently deformed in response to the vibrations conducted to the coupling plate spring 20 to displace, i.e., move the frictional contact portion 21c in the longitudinal direction.

Here, although wear particles are generated by the sliding friction between the frictional contact portions 21c, 33a, the displacement enabling portions 70, 73 are resiliently deformed to displace, i.e.. move the frictional contact portions 33a, 21c in the longitudinal direction.

Therefore, the wear particles can be expelled from the location between the frictional contact portions 33a, 21c. Thus, it is possible to limit occurrence of damage of the frictional contact portions 33a, 21c caused by the wear particles. As a result, it is possible to limit acceleration of the wearing of the frictional contact portions 33a, 21c.

In the present embodiment, as described above, the displacement enabling portions 73, 70 have the different shapes, respectively, which are different from each other. Therefore, the rigidity of the displacement enabling portion 73 and the rigidity of the displacement enabling portion 70 are different from each other. Thus, the displacement enabling portions 73, 70 generate different vibrations at the frictional contact portions 21c, 33a, respectively. As a result, the wear particles can be further effectively expelled from the location between the frictional contact portions 33a, 210.

### Eighth Embodiment

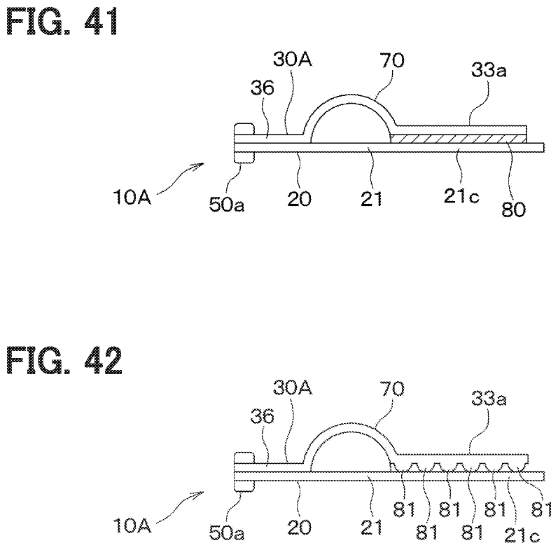

In an eighth embodiment (a modification of the third embodiment), with reference to FIG. 41, there will be described an example where a thin plate shaped elastic member 80 is placed between the frictional contact portion 33a of the plate spring 30A and the frictional contact portion 21c of the coupling plate spring 20 at the spring unit 10A of the third embodiment.

FIG. 41 is a side view showing a portion of the spring unit 10A of the present embodiment. In FIG. 41, the portions, which are the same as those of FIG. 23, are indicated by the same references signs as those of FIG. 23, and redundant description thereof will be omitted for the sake of simplicity.

The spring unit 10A of the eighth embodiment includes the thin plate shaped elastic member 80 provided to the spring unit 10A of the third embodiment. The thin plate shaped elastic member 80 is an elastic member made of an elastic material, such as rubber. The thin plate shaped elastic member 80 can improve the effect of the sliding friction between the frictional contact portion 21c of the plate spring segment 21 of the coupling plate spring 20 and the frictional contact portion 33a of the plate spring 30A.

### Ninth Embodiment

In a ninth embodiment (a modification of the third embodiment), with reference to FIG. 42, there will be described an example where a plurality of projections 81 are arranged at the frictional contact portion 33a of the plate spring 30A in the spring unit 10A of the third embodiment.

FIG. 42 is a side view showing a portion of the spring unit 10A of the present embodiment. In FIG. 42, the portions, which are the same as those of FIG. 23, are indicated by the same references signs as those of FIG. 23, and redundant description thereof will be omitted for the sake of simplicity.

The plurality of projections 81 of the frictional contact portion 33a of the plate spring 30A respectively contact the frictional contact portion 21c of the plate spring segment 21 of the coupling plate spring 20. Therefore, even when the vibrations of different frequencies are generated at the spring unit 10A, the sliding friction can be generated between one or more of the projections 81 of the plate spring 30A and the frictional contact portion 21c of the plate spring segment 21. Therefore, the vibrations of the plurality of frequencies can be attenuated by the spring unit 10A.

### Tenth Embodiment

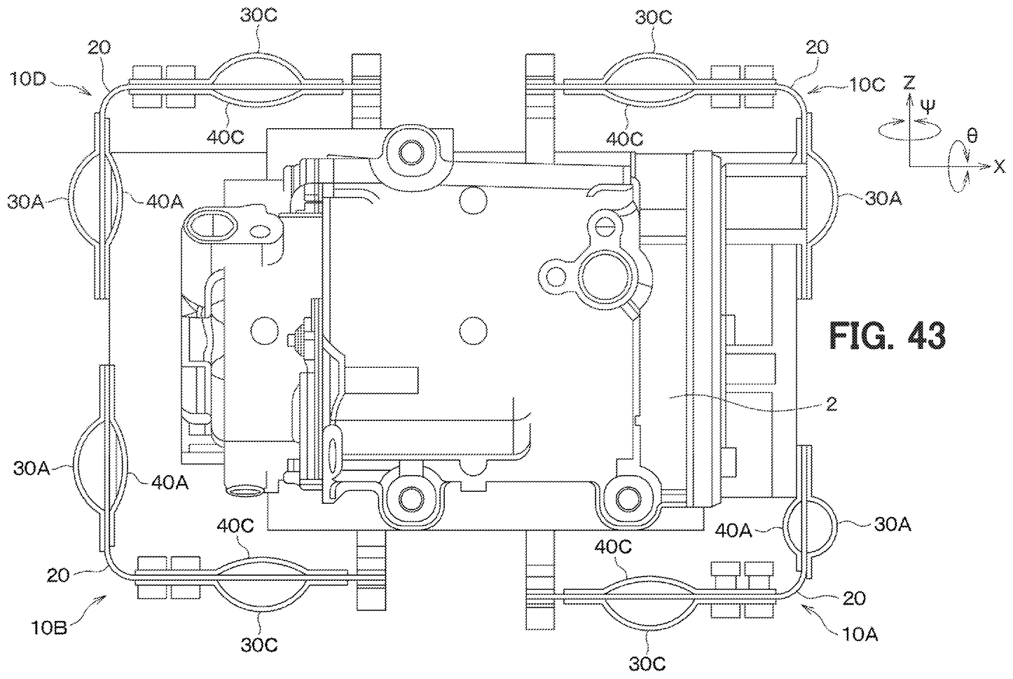

In a tenth embodiment (a modification of the third embodiment), with reference to FIGS. 43, 44 and 45, there will be described an example where the plate spring 30A applies a resilient force against the plate spring segment 21 of the coupling plate spring 20 in the thickness direction of coupling plate spring 20 in the spring unit 10A of the fourth embodiment.

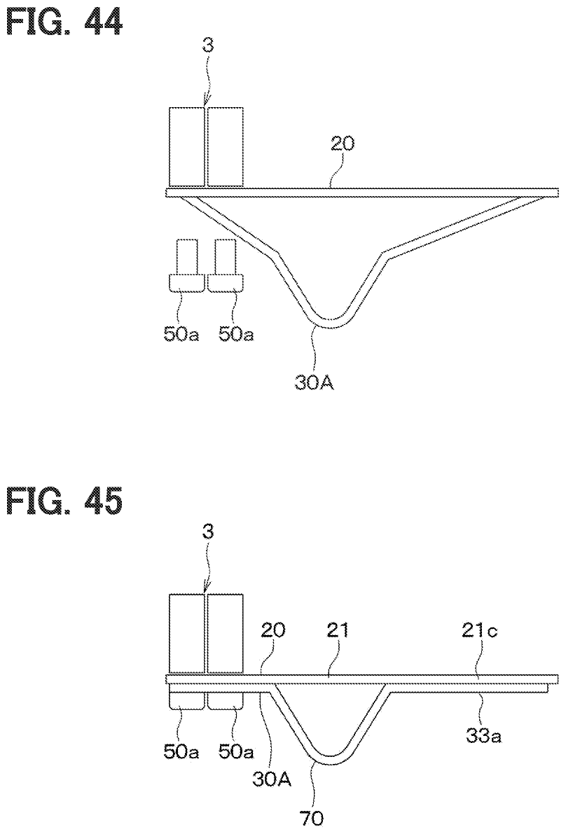

FIG. 43 is a front view showing an overall structure of the vehicular vibration isolator of the tenth embodiment. FIGS, 44 and 45 are a side view showing a portion of the spring unit 10A of the present embodiment. In FIGS. 44 and 45, the portions, which are the same as those of FIG. 23, are indicated by the same references signs as those of FIG. 23, and redundant description thereof will be omitted for the sake of simplicity.

In the spring unit 10A of the present embodiment, the plate spring 30A is resiliently deformed at the time of fixing the plate spring 30A to the coupling plate spring 20 by the two bolts 50a. Therefore, as shown in FIGS. 44 and 45, the plate spring 30A and the coupling plate spring 20 are fixed together by the bolts 50a in a state where the plate spring 30A is resiliently deformed and thereby applies the resilient force to the frictional contact portion 21c of the coupling plate spring 20. In FIGS. 44 and 45, indication of the plate spring 40A is omitted for the sake of simplicity.

Therefore, the frictional contact portion 33a of the plate spring 30A applies the resilient force (i.e., a preload) to the frictional contact portion 21c of the coupling plate spring 20. At this time, the vibration attenuation effect of the sliding friction, which is generated between the frictional contact portion 21c of the coupling plate spring 20 and the frictional contact portion 33a of the plate spring 30A, can be improved.

Furthermore, in the spring unit 10A, the plate spring 40A is resiliently deformed at the time of fixing the plate spring 40A to the coupling plate spring 20 by the bolts 50a. Therefore, the plate spring 40A and the coupling plate spring 20 are fixed together by the bolts 50a in a state where the plate spring 40A is resiliently deformed.

In the spring unit 10A, the configurations of the plate springs 30B, 30C, 40B, 40C are similar to the configurations of the plate springs 30A, 40A. The configurations of the spring units 10B, 10C are similar to the configuration of the spring unit 10A.

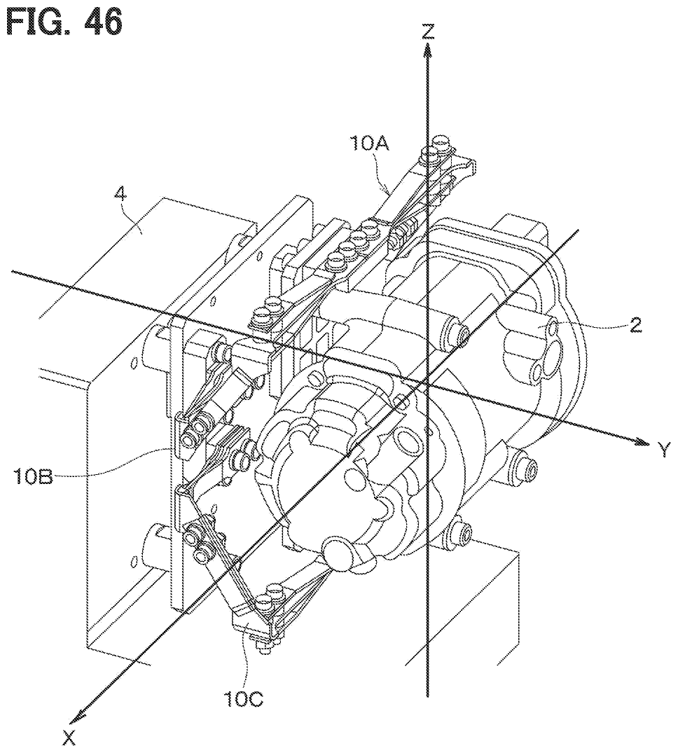

Next, the vibration attenuation effect of the spring units 10A, 10B, 10C of the tenth embodiment will be described with reference to FIGS. 46 to 49.

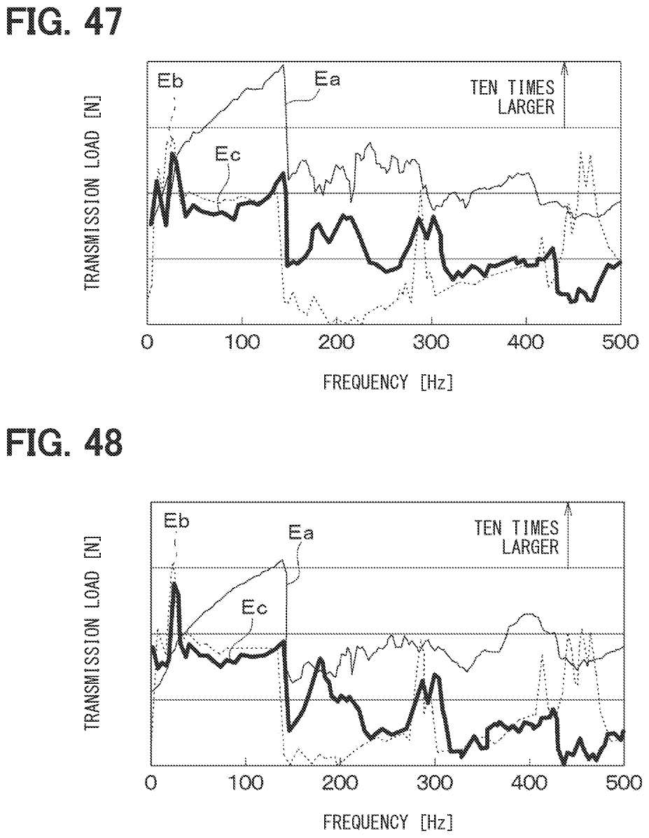

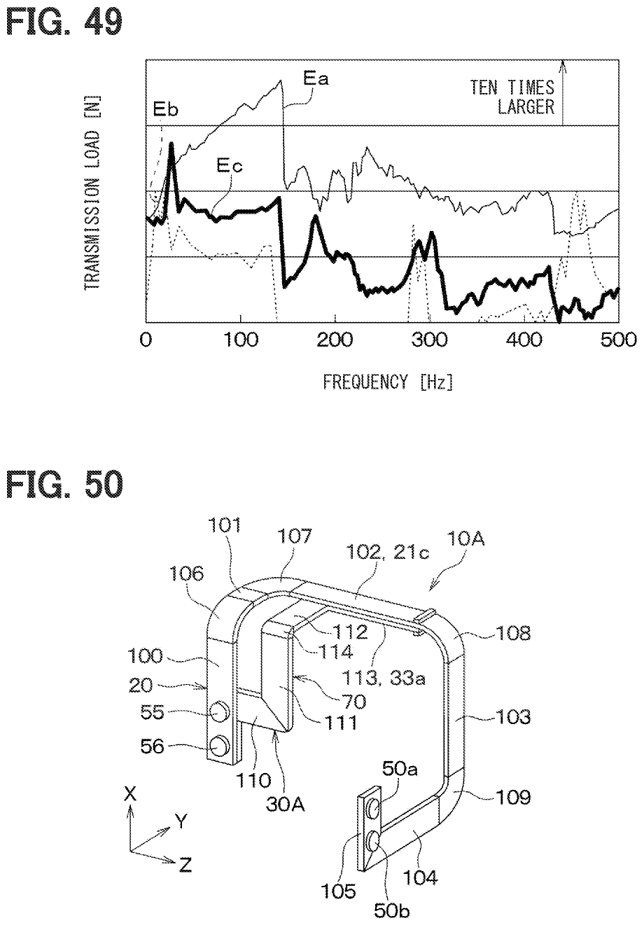

FIG. 46 indicates a state where the compressor 2 is fixed to a fixing bracket 4 through the spring units 10A, 10B, 10C to obtain results of measurements for checking the attenuation of the vibrations. FIGS. 47, 48 and 49 indicate the attenuations of the vibrations by the spring units 10A, 10B, 10C in a case where the vibrations of 0.1 Hz to 1 Hz are applied to the compressor 2. In a graph of FIG. 47, a horizontal axis indicates a frequency, and a vertical axis indicates a transmission load [N] in the X direction conducted from the compressor 2 to the fixing bracket 4, and lines Ea, Eb, Ec respectively indicate a corresponding change in the transmission load [N] in the X direction conducted from the compressor 2 to the fixing bracket 4 with respect to the frequency for various cases described below. In a graph of FIG. 48, a horizontal axis indicates the frequency, and a vertical axis indicates a transmission load [N] in the Y direction conducted from the compressor 2 to the fixing bracket 4, and lines Ea, Eb, Ec respectively indicate a corresponding change in the transmission load [N] in the Y direction conducted from the compressor 2 to the fixing bracket 4 with respect to the frequency for various cases described below. In a graph of FIG. 49, a horizontal axis indicates the frequency, and a vertical axis indicates a transmission load [N] in the Z direction conducted from the compressor 2 to the fixing bracket 4, and lines Ea, Eb, Ec respectively indicate a corresponding change in the transmission load [N] in the Z direction conducted from the compressor 2 to the fixing bracket 4 with respect to the frequency for various cases described below.

The line Ea of each of the graphs of FIGS. 47, 48 and 49 is obtained in a case where the spring units 10A, 10B, 10C are not provided.

The line Eb of the graph of FIG. 47 is obtained in a case where the preload, which is applied to the plate springs 30A, 40A that attenuate the vibration in the X direction, is made small at the spring units 10A, 10B, 10C. The line Ec of the graph of FIG. 47 is obtained in a case where the sufficient preload (i.e., the preload of the present embodiment) is applied to the plate springs 30A, 40A that attenuate the vibration in the X direction at the spring units 10A, 10B, 10C.

The line Eb of the graph of FIG. 48 is obtained in a case where the preload, which is applied to the plate springs 30B, 40B that attenuate the vibration in the Y direction, is made small at the spring units 10A, 10B, 10C. The line Ec of the graph of FIG. 48 is obtained in a case where the sufficient preload is applied to the plate springs 30B, 40B that attenuate the vibration in the Y direction at the spring units 10A, 10B, 10C.

The line Eb of the graph of FIG. 49 is obtained in a case where the preload, which is applied to the plate springs 30C, 40C that attenuate the vibration in the Z direction, is made small at the spring units 10A, 10B, 10C. The line Ec of the graph of FIG. 49 is obtained in a case where the sufficient preload is applied to the plate springs 30C, 40C that attenuate the vibration in the Z direction at the spring units 10A, 10B, 10C.

As understood from the lines Eb, Ec of the graphs of FIGS. 47, 48 and 49, the vibration in the X direction, the vibration in the Y direction and the vibration in the Z direction can be attenuated in the cases where the sufficient preload is applied to each of the plate springs 30A, 30B, 30C, 40A, 40B, 40C.

In the third to tenth embodiments, in the spring unit 10A, the displacement enabling portion 70, 71 of each of the plate springs 30A, 40A serves as a primary intervening portion which is located between the frictional contact portion 33a, 43a and the fixing portion 36, 46 of the plate spring 30A, 40A (i.e., the fixing portion 36, 46 having the one or more through-holes 31a, 32a, 41a, 42a for receiving the one or more bolts 50a, 50b). Also, the displacement enabling portion 70, 71 of each of the plate springs 30B, 40B serves as a secondary intervening portion which is located between the frictional contact portion 33b, 43b and the fixing portion 66, 76 of the plate spring 3DB, 40B (i.e., the fixing portion 66, 76 having the one or more through-holes 31b, 32b, 41b, 42b for receiving the one or more bolts 51a, 51b). Furthermore, the displacement enabling portion 70, 71 of each of the plate springs 30C, 40C serves as a tertiary intervening portion which is located between the frictional contact portion 33c, 43c and the fixing portion 86, 96 of the plate spring 30C, 40C (i.e., the fixing portion 86, 96 having the one or more through-holes 31c, 32c, 41c, 42c for receiving the one or more bolts 52a, 52b).

### Eleventh Embodiment

In the third embodiment, there is described the example where the frictional contact portion 33a is displaced, i.e., is moved relative to the frictional contact portion 21c of the coupling plate spring 20 in the longitudinal direction by the resilient deformation of the displacement enabling portion 70.

Alternatively, with reference to FIG. 50, there will be described an eleventh embodiment, in which the frictional contact portion 33a is displaced, i.e,, is moved relative to the frictional contact portion 21c of the coupling plate spring 20 in the width direction of the frictional contact portion 21c by the resilient deformation of the displacement enabling portion 70.

FIG. 50 is a side view showing an overall structure of the spring unit 10A of the present embodiment. In FIG. 50, the portions, which are the same as those of FIG. 23, are indicated by the same references signs as those of FIG. 23, and redundant description thereof will be omitted for the sake of simplicity.

The coupling plate spring 20 includes a plurality of elongated plate spring portions 100, 101, 102, 103, 104, 105 and a plurality of connecting portions 106 107, 108, 109.

The elongated plate spring portion 100 is formed such that a longitudinal direction of the elongated plate spring portion 100 coincides with the X direction. The elongated plate spring portion 100 is also formed such that a thickness direction of the elongated plate spring portion 100 coincides with the Y direction, and a width direction of the elongated plate spring portion 100 coincides with the Z direction.

The elongated plate spring portion 101 is formed such that a longitudinal direction of the elongated plate spring portion 101 coincides with the Y direction. The elongated plate spring portion 101 is also formed such that a thickness direction of the elongated plate spring portion 101 coincides with the X direction, and a width direction of the elongated plate spring portion 101 coincides with the Z direction. The connecting portion 106 connects between one longitudinal end portion of the elongated plate spring portion 100 to one longitudinal end portion of the elongated plate spring portion 101.

The elongated plate spring portion 102 is formed such that a longitudinal direction of the elongated plate spring portion 102 coincides with the Z direction. The elongated plate spring portion 102 is also formed such that a thickness direction of the elongated plate spring portion 102 coincides with the X direction, and a width direction of the elongated plate spring portion 102 coincides with the Y direction. The elongated plate spring portion 102 of the present embodiment forms the frictional contact portion 21c which s idably contacts the plate spring 30A. The connecting portion 107 connects between the other longitudinal end portion of the elongated plate spring portion 101 to one longitudinal end portion of the elongated plate spring portion 102.

The elongated plate spring portion 103 is formed such that a longitudinal direction of the elongated plate spring portion103 coincides with the X direction. The elongated plate spring portion 103 is also formed such that a thickness direction of the elongated plate spring portion 103 coincides with the Z direction, and a width direction of the elongated plate spring portion 103 coincides with the Y direction. The connecting portion 108 connects between the other longitudinal end portion of the elongated plate spring portion 102 to one longitudinal end portion of the elongated plate spring portion 103.

The elongated plate spring portion 104 is formed such that a longitudinal direction of the elongated plate spring portion 104 coincides with the Y direction. The elongated plate spring portion 104 is also formed such that a thickness direction of the elongated plate spring portion 104 coincides with the Z direction, and a width direction of the elongated plate spring portion 104 coincides with the X direction. The connecting portion 109 connects between the other longitudinal end portion of the elongated plate spring portion 103 to one longitudinal end portion of the elongated plate spring portion 104.

The elongated plate spring portion 105 is formed such that a longitudinal direction of the elongated plate spring portion 105 coincides with the X direction. The elongated plate spring portion 105 is joined to and is fixed to the traveling engine 3 (i.e., the vibration receiving object) by the bolts 50a, 50b.

The elongated plate spring portion 105 is also formed such that a thickness direction of the elongated plate spring portion 105 coincides with the Z direction, and a width direction of the elongated plate spring portion 105 coincides with the Y direction. The elongated plate spring portion 105 extends from the other longitudinal end portion of the elongated plate spring portion 104 in the X direction.

The plate spring 30A includes a plurality of elongated plate spring portions 110, 111, 112, 113 and a connecting portion 114. The elongated plate spring portion 110 is formed such that a longitudinal direction of the elongated plate spring portion 110 coincides with the Z direction. The elongated plate spring portion 110 is also formed such that a thickness direction of the elongated plate spring portion 110 coincides with the Y direction, and a width direction of the elongated plate spring portion 110 coincides with the X direction.

The elongated plate spring portion 111 is formed such that a longitudinal direction of the elongated plate spring portion 111 coincides with the X direction. The elongated plate spring portion 111 is also formed such that a thickness direction of the elongated plate spring portion 111 coincides with the Y direction, and a width direction of the elongated plate spring portion 111 coincides with the Z direction.

One longitudinal end portion of the elongated plate spring portion 111 is connected to one longitudinal end portion of the elongated plate spring portion 110.

The elongated plate spring portion 112 is formed such that a longitudinal direction of the elongated plate spring portion 112 coincides with the Y direction. The elongated plate spring portion 112 is also formed such that a thickness direction of the elongated plate spring portion 112 coincides with the X direction, and a width direction of the elongated plate spring portion 112 coincides with the Z direction.

The connecting portion 114 connects between the other longitudinal end portion of the elongated plate spring portion 111 to one longitudinal end portion of the elongated plate spring portion 112.

The elongated plate spring portion 113 is formed such that a longitudinal direction of the elongated plate spring portion 113 coincides with the Z direction. The elongated plate spring portion 113 is also formed such that a thickness direction of the elongated plate spring portion 113 coincides with the X direction, and a width direction of the elongated plate spring portion 113 coincides with the Y direction. One longitudinal end portion of the elongated plate spring portion 113 is connected to the other longitudinal end portion of the elongated plate spring portion 112.

The elongated plate spring portion 113 of the present embodiment forms the frictional contact portion 33a which slidably contacts the coupling plate spring 20. The frictional contact portion 33a is formed at a portion of the plate spring 30A which is other than the elongated plate spring portion 110 (i.e., a fixing portion) that is joined to and is fixed to the coupling plate spring 20 by the bolts 55, 56.

In the present embodiment, the elongated plate spring portion 110 of the plate spring 30A is joined to and is fixed to the elongated plate spring portion 100 of the coupling plate spring 20 and the compressor 2 (i.e., the vibration source) by the bolts 55, 56.

Therefore, the elongated plate spring portion 110 of the plate spring 30A forms a fixing portion that is fixed to the elongated plate spring portion 100 of the coupling plate spring 20 and the compressor 2. Specifically, the coupling plate spring 20 extends between the compressor 2 and the traveling engine 3 and couples between the compressor 2 and the traveling engine 3.

The elongated plate spring portion 113 is arranged such that the elongated plate spring portion 113 overlaps the elongated plate spring portion 102 of the coupling plate spring 20 in the X direction (i.e., the thickness direction).

The elongated plate spring portions 110, 111, 112 and the connecting portion 114 of the plate spring 30A form the displacement enabling portion 70 that displaces, i.e., moves the frictional contact portion 33a relative to the frictional contact portion 21c of the plate spring segment 21 at the elongated plate spring portion 102 when the displacement enabling portion 70 is resiliently deformed in response to the vibrations. The displacement enabling portion 70 is shifted, i.e., is dislocated relative the elongated plate spring portions 100, 101 and the connecting portion 106 of the coupling plate spring 20 toward one side in the Z direction (i.e., one side in the width direction). In other words, the displacement enabling portion 70 is formed to extend along the elongated plate spring portions 100, 101 and the connecting portion 106 of the coupling plate spring 20 while a gap is formed between the elongated plate spring portions 100, 101 and the connecting portion 106 of the coupling plate spring 20 and the displacement enabling portion 70.

In the present embodiment configured in the above-described manner, the vibrations are conducted from the compressor 2 to the plate spring 30A through the coupling plate spring 20 at the spring unit 10A. At this time, the sliding friction is generated between the frictional contact portion 21c of the plate spring segment 21 of the coupling plate spring 20 and the frictional contact portion 33a of the plate spring 30A, Therefore, among the vibrations conducted to the spring unit 10A, the vibration in the X direction can be attenuated.

The frictional contact portion 33a of the plate spring 30A is formed to extend in the Z direction (i.e., a predetermined direction). The frictional contact portion 21c of the plate spring segment 21 of the coupling plate spring 20 extends in the Z direction (i.e., the predetermined direction) and connects between the compressor 2 and the traveling engine 3. The frictional contact portion 33a is arranged such that the frictional contact portion 33a overlaps the frictional contact portion 21c in the X direction.

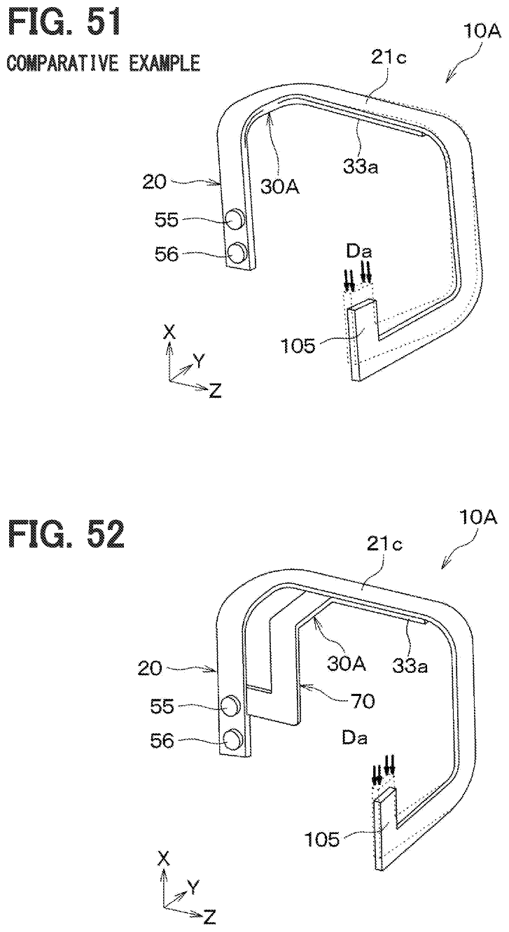

At this time, the displacement enabling portion 70 of the plate spring 30A is resiliently deformed in response to the vibrations to displace, i.e., move the frictional contact portion 33a in the Y direction (i.e., the width direction). Here, as shown in FIG. 51, in a case of the spring unit 10A in which the displacement enabling portion 70 is not formed at the plate spring 30A, the amount of sliding displacement (the amount of sliding movement) of the frictional contact portion 33a in the Y direction (i.e., the width direction) is small,

In contrast, with reference to FIG. 52, in the case of the spring unit 10A of the present embodiment where the displacement enabling portion 70 is formed at the plate spring 30A, the amount of sliding displacement (the amount of sliding movement) of the frictional contact portion 33a in the Y direction (i.e., the width direction) becomes large.

Here, although wear particles are generated by the sliding friction between the frictional contact portions 21c, 33a, the displacement enabling portion 70 is resiliently deformed to displace, i.e., move the frictional contact portion 33a in the width direction of the frictional contact portion 21c. Therefore, the wear particles can be expelled from the location between the frictional contact portions 33a, 21c. Thus, it is possible to limit occurrence of damage of the frictional contact portions 33a, 21c caused by the wear particles, As a result, it is possible to limit acceleration of the wearing of the frictional contact portions 33a, 21c.

In the present embodiment, the Y direction, in which the frictional contact portion 33a is slid and is displaced (i.e., is moved) back and forth relative to the frictional contact portion 21c, is a direction that intersects the longitudinal direction (i.e., Z direction) of the frictional contact portions 33a, 21c (more specifically, a direction that is perpendicular to the longitudinal direction of the frictional contact portions 33a, 21c, i.e., the Z direction).

Here, it should be noted that FIGS. 51 and 52 show examples where the frictional contact portion 33a of the plate spring 30A is slid and is displaced relative to the frictional contact portion 21c of the coupling plate spring 20 in the Y direction when the elongated plate spring portion 105 is forcefully displaced by 250 μm by applying the load to the elongated plate spring portion 105.

FIG. 51 shows the example where the frictional contact portion 33a of the plate spring 30A is slid and is displaced by 26 μm in the Y direction relative to the frictional contact portion 21c of the coupling plate spring 20. FIG. 52 shows the example where the frictional contact portion 33a of the plate spring 30A is slid and is displaced by 131 μm in the Y direction relative to the frictional contact portion 21c of the coupling plate spring 20.

### Twelfth Embodiment

In the eleventh embodiment, there is described the example where the displacement enabling portion 70 of the plate spring 30A is shifted, i.e., is dislocated relative to the elongated plate spring portions 100, 101 and the connecting portion 106 of the coupling plate spring 20 toward the one side in the Z direction.

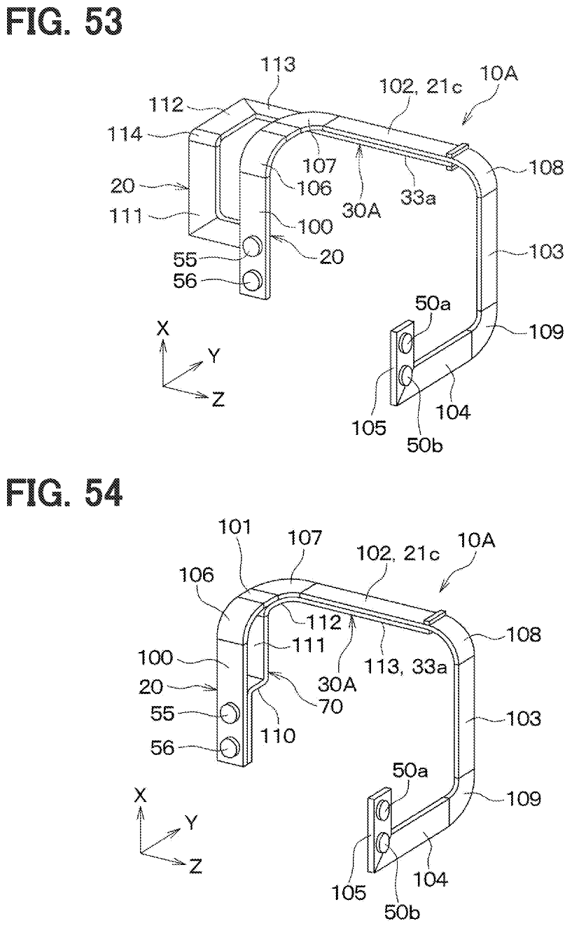

Alternative to this configuration, with reference to FIG. 53, there will be described a twelfth embodiment (a modification of the eleventh embodiment), in which the displacement enabling portion 70 of the plate spring 30A is shifted, i.e., is dislocated relative to the elongated plate spring portions 100, 101 and the connecting portion 106 of the coupling plate spring 20 toward the other side in the Z direction.

In FIG. 53. the portions, which are the same as those of FIG. 50, are indicated by the same references signs as those of FIG. 50, and redundant description thereof will be omitted for the sake of simplicity.

The plate spring 30A of the present embodiment and the plate spring 30A of the eleventh embodiment differ only in the position of the displacement enabling portion 70, and the rest of the structure of the plate spring 30A of the present embodiment is the same as that of the plate spring 30A of the eleventh embodiment.

In the present embodiment constructed in the above-described manner, like in the eleventh embodiment, the sliding friction is generated between the frictional contact portion 21c of the plate spring segment 21 of the coupling plate spring 20 and the frictional contact portion 33a of the plate spring 30A. Therefore, among the vibrations conducted to the spring unit 10A, the vibration in the X direction can be attenuated.

At this time, the displacement enabling portion 70 of the plate spring 30A is resiliently deformed in response to the vibrations to displace the frictional contact portion 33a in the Y direction (i.e., the width direction). Therefore, the wear particles can be expelled from the location between the frictional contact portions 33a, 21c. Thus, it is possible to limit occurrence of damage of the frictional contact portions 33a, 21c caused by the wear particles. As a result, it is possible to limit acceleration of the wearing of the frictional contact portions 33a, 21c.

### Thirteenth Embodiment

In the eleventh embodiment, there is described the example where the displacement enabling portion 70 of the plate spring 30A is shifted, i.e., is dislocated relative to the elongated plate spring portions 100, 101 and the connecting portion 106 of the coupling plate spring 20 toward the one side in the Z direction.

Alternative to this configuration, with reference to FIG. 54, there will be described a thirteenth embodiment (a modification of the eleventh embodiment), in which the displacement enabling portion 70 of the plate spring 30A is shifted, i.e., is dislocated relative to the elongated plate spring portions 100, 101 of the coupling plate spring 20 in the Y direction.

In FIG. 54, the portions, which are the same as those of FIG. 50, are indicated by the same references signs as those of FIG. 50, and redundant description thereof will be omitted for the sake of simplicity.

The plate spring 30A of the present embodiment and the plate spring 30A of the eleventh embodiment differ only in the position of the displacement enabling portion 70, and the rest of the structure of the plate spring 30A of the present embodiment is the same as that of the plate spring 30A of the eleventh embodiment.

In the present embodiment constructed in the above-described manner, like in the eleventh embodiment, the sliding friction is generated between the frictional contact portion 21c of the plate spring segment 21 of the coupling plate spring 20 and the frictional contact portion 33a of the plate spring 30A. Therefore, among the vibrations conducted to the spring unit 10A, the vibration in the X direction can be attenuated.

At this time, the displacement enabling portion 70 of the plate spring 30A is resiliently deformed in response to the vibrations to displace, i.e., move the frictional contact portion 33a in the Y direction the width direction). Therefore, the wear particles can be expelled from the location between the frictional contact portions 33a, 21c. Thus, it is possible to limit occurrence of damage of the frictional contact portions 33a, 21c caused by the wear particles. As a result, it is possible to limit acceleration of the wearing of the frictional contact portions 33a, 21c.

### Fourteenth Embodiment

In the fourth embodiment, there is described the example where the plate spring segment 21 of the coupling plate spring 20 linearly extends in the Z direction in the spring unit 10A.

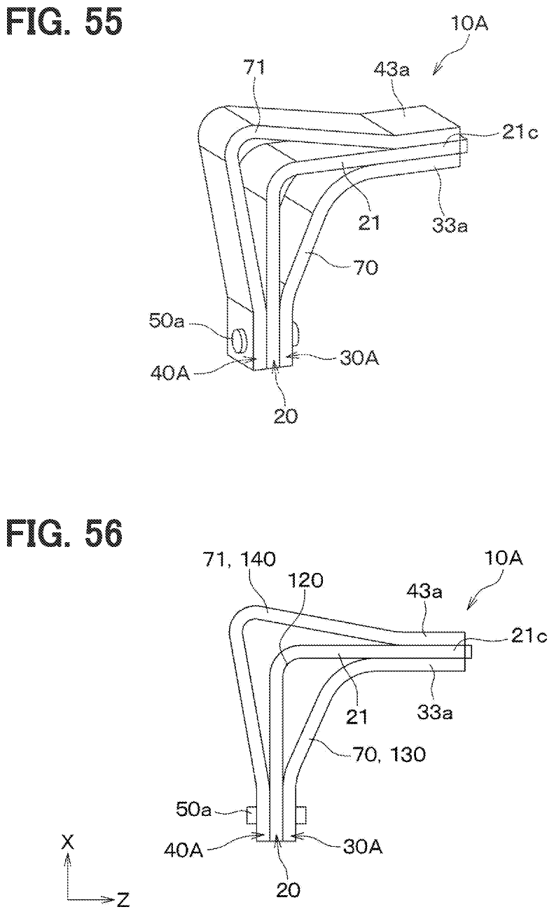

Alternatively, with reference to FIGS. 55 and 56, there will be described a fourteenth embodiment (a modification of the fourth embodiment), in which the spring unit 10A of the fourth embodiment is modified such that the plate spring segment 21 of the coupling plate spring 20 is bent.

In FIGS. 55 and 56, the portions, which are the same as those of FIG. 28, are indicated by the same references signs as those of FIG. 28, and redundant description thereof will be omitted for the sake of simplicity.

The spring unit 10A of the present embodiment includes the coupling plate spring 20 and the plate springs 30A, 40A. The plate spring 30A is arranged such that the plate spring 30A overlaps the coupling plate spring 20 in the thickness direction. The plate spring 40A is arranged such that the plate spring 40A overlaps the coupling plate spring 20 in the thickness direction.

The plate spring 30A is located on one side of the coupling plate spring 20 in the thickness direction of the coupling plate spring 20. The plate spring 40A is located on the other side of the coupling plate spring 20 in the thickness direction of the coupling plate spring 20. Each of the plate springs 30A, 40A is bent like the coupling plate spring 20.

A bent portion 130 of the plate spring 30A is spaced from a bent portion 120 of the coupling plate spring 20 by a gap. A bent portion 140 of the plate spring 40A is spaced from the bent portion 120 of the coupling plate spring 20 by a gap.

A portion of the plate spring 30A, which is located on the one longitudinal side of the bent portion 130, and a portion of the plate spring 40A, which is located on the one longitudinal side of the bent portion 140, are joined to and are fixed to the coupling plate spring 20 by the bolt 50a.

A portion of the plate spring 30A, which is located on the other longitudinal side of the bent portion 130, forms the frictional contact portion 33a. A portion of the plate spring 40A, which is located on the other longitudinal side of the bent portion 140, forms the frictional contact portion 43a A portion of the coupling plate spring 20, which is located on the other longitudinal side of the bent portion 120, forms the frictional contact portion 21c.

In the present embodiment, the bent portion 130 of the plate spring 30A forms the displacement enabling portion 70 that is configured to be resiliently deformed in response to the vibrations to displace, i.e., move the frictional contact portion 33a in the longitudinal direction. The bent portion 140 of the plate spring 40A forms the displacement enabling portion 71 that is configured to be resiliently deformed in response to the vibrations to displace, i.e., move the frictional contact portion 43a in the longitudinal direction.

In the present embodiment configured in the above-described manner, the vibrations are conducted from the compressor 2 to the spring unit 10A. The vibrations conducted to the spring unit 10A cause the frictional contact portion 33a of the plate spring 30A and the frictional contact portion 43a of the plate spring 40A to generate the sliding friction relative to the frictional contact portion 21c of the plate spring segment 21 of the coupling plate spring 20. Therefore, among the vibrations conducted to the spring unit 10A, the vibration (vibration component) in the X direction can be attenuated.

At this time, the wear particles are generated by the sliding friction between each of the frictional contact portions 33a, 43a of the plate springs 30A, 40A and the frictional contact portion 21c of the plate spring segment 21 of the coupling plate spring 20.

The displacement enabling portion 70 is resiliently deformed in response to the vibrations conducted from the compressor 2 to the plate spring 30A of the spring unit 10A, so that the frictional contact portion 33a is displaced, i.e., is moved back and forth relative to the frictional contact portion 21c in the longitudinal direction (i.e., the Z direction). Therefore, the wear particles can be expelled from the location between the frictional contact portion 33a and the frictional contact portion 21c. As a result, it is possible to limit acceleration of the wearing of the frictional contact portions 33a, 21c.

The displacement enabling portion 71 is resiliently deformed by the vibration conducted from the compressor 2 to the plate spring 40A, so that the frictional contact portion 43a is displaced, i.e., is moved back and forth relative to the frictional contact portion 21c in the longitudinal direction (i.e., the Z direction). Therefore, the wear particles can be expelled from the location between the frictional contact portion 43a and the frictional contact portion 21c.

Thus, it is possible to limit occurrence of damage of the frictional contact portions 33a, 43a, 21c caused by the wear particles. As a result, it is possible to limit acceleration of the wearing of the frictional contact portions 33a, 43a, 21c.

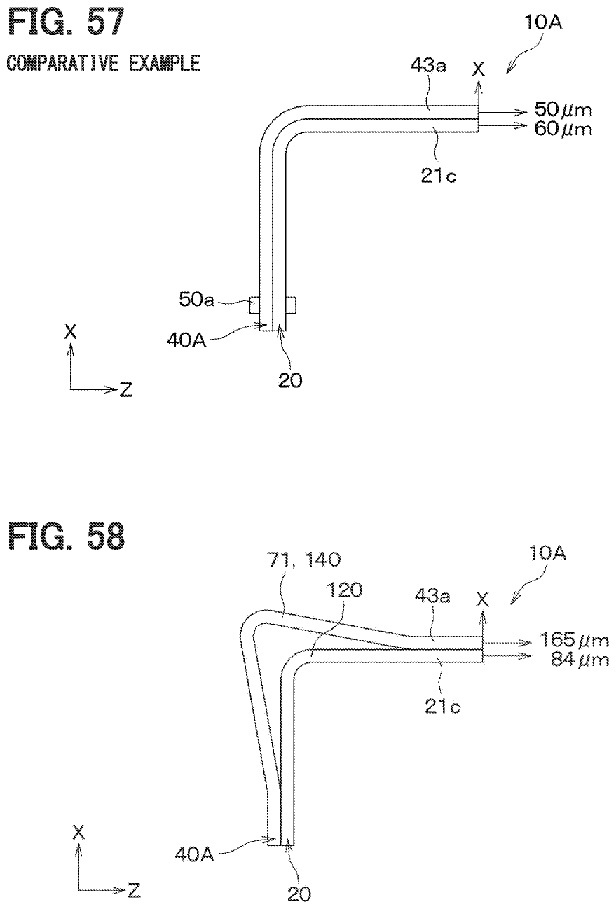

FIGS. 57, 58, 59 and 60 show results of an experiment for forcefully displacing the spring unit 10A by 250 μm in the X direction.

FIG. 57 indicates a case where the plate spring 40A, which does not have the displacement enabling portion 71, and the coupling plate spring 20 are forcefully displaced by 250 μm toward the one side in the X direction. FIG. 58 indicates a case where the plate spring 40A of the present embodiment, which has the displacement enabling portion 71, and the coupling plate spring 20 are forcefully displaced by 250 μm toward the one side in the X direction.

In the case where the plate spring 40A, which does not have the displacement enabling portion 71, and the coupling plate spring 20 are forcefully displaced by 250 μm toward the one side in the X direction, the plate spring 40A is displaced by 50 μm toward the one side in the Z direction, and the coupling plate spring 20 is displaced by 60 μm toward the one side in the Z direction. In this case, the frictional contact portion 43a is slid and is displaced by 10 μm relative to the frictional contact portion 21c.

In the other case where the plate spring 40A, which has the displacement enabling portion 71, and the coupling plate spring 20 are forcefully displaced by 250 μm toward the one side in the X direction, the plate spring 40A is displaced by 165 μm toward the one side in the Z direction, and the coupling plate spring 20 is displaced by 84 μm toward the one side in the Z direction. In this case, the frictional contact portion 43a is slid and is displaced by 81 μm relative to the frictional contact portion 21c.

Therefore, the plate spring 40A, which has the displacement enabling portion 71, can increase the amount of sliding displacement of the frictional contact portion 43a relative to the frictional contact portion 21c in comparison to the case where the plate spring 40A does not have the displacement enabling portion 71.

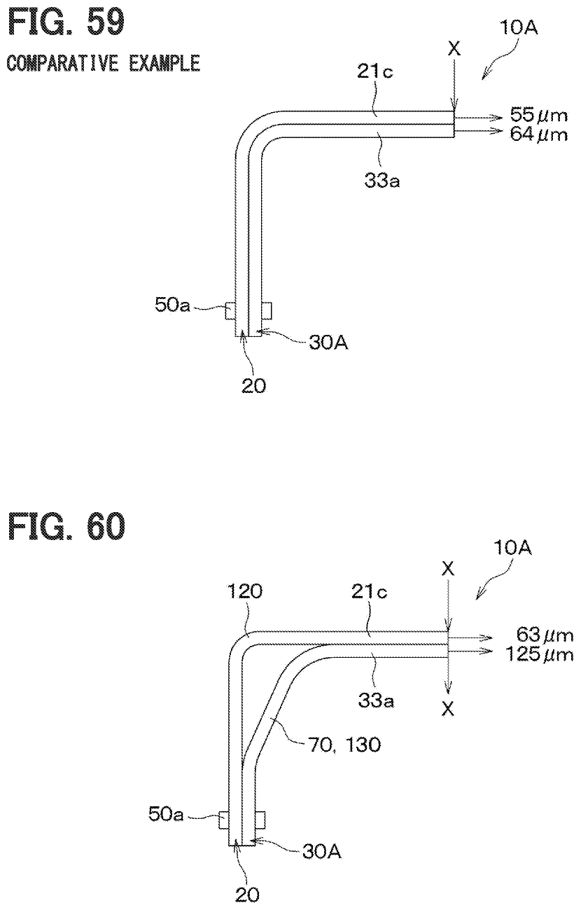

FIG. 59 indicates a case where the plate spring 30A, which does not have the displacement enabling portion 70, and the coupling plate spring 20 are forcefully displaced by 250 μm toward the other side in the X direction. FIG. 60 indicates a case where the plate spring 30A of the present embodiment, which has the displacement enabling portion 70, and the coupling plate spring 20 are forcefully displaced by 250 μm toward the other side in the X direction.

In the case where the plate spring 30A, which does not have the displacement enabling portion 70, and the coupling plate spring 20 are forcefully displaced by 250 μm toward the other side in the X direction, the plate spring 30A is displaced by 64 μm toward the one side in the Z direction, and the coupling plate spring 20 is displaced by 55 μm toward the one side in the Z direction. In this case, the frictional contact portion 33a is slid and is displaced by 9 μm relative to the frictional contact portion 21c.

In the other case where the plate spring 30A, which has the displacement enabling portion 70, and the coupling plate spring 20 are forcefully displaced by 250 μm toward the other side in the X direction, the plate spring 30A is displaced by 125 μm toward the one side in the Z direction, and the coupling plate spring 20 is displaced by 63 μm toward the one side in the Z direction. In this case, the frictional contact portion 33a is slid and is displaced by 62 μm relative to the frictional contact portion 21c.

Therefore, the plate spring 30A, which has the displacement enabling portion 70, can increase the amount of sliding displacement of the frictional contact portion 33a relative to the frictional contact portion 21c in comparison to the case where the plate spring 30A does not have the displacement enabling portion 70,

### Fifteenth Embodiment

In the fourteenth embodiment described above, there is described the spring unit 10A where the gap, which is shaped in a triangular form, is formed between the bent portion 120 of the coupling plate spring 20 and the bent portion 130 of the plate spring 30A.

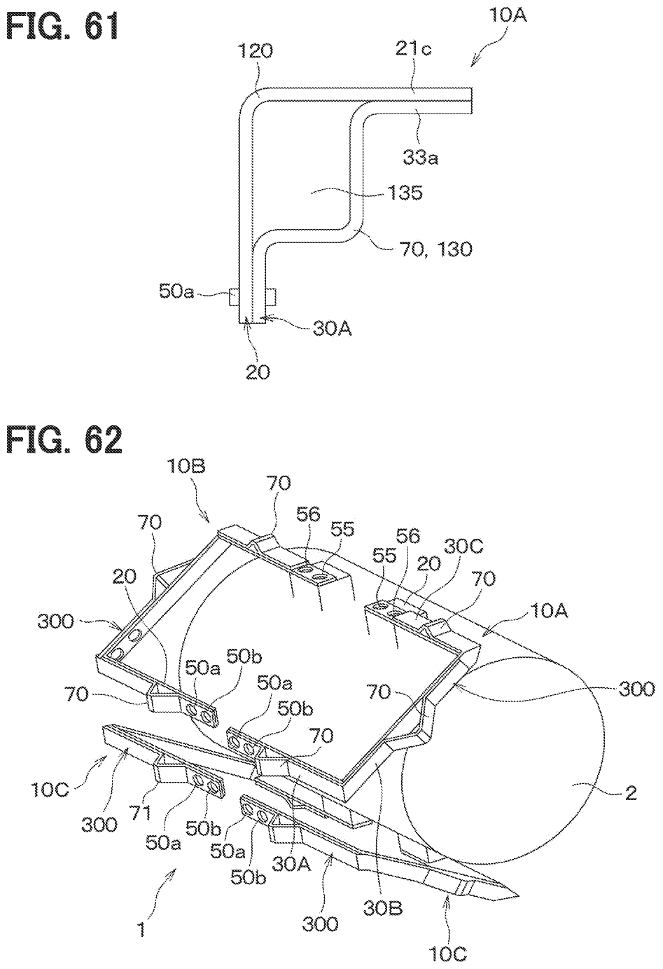

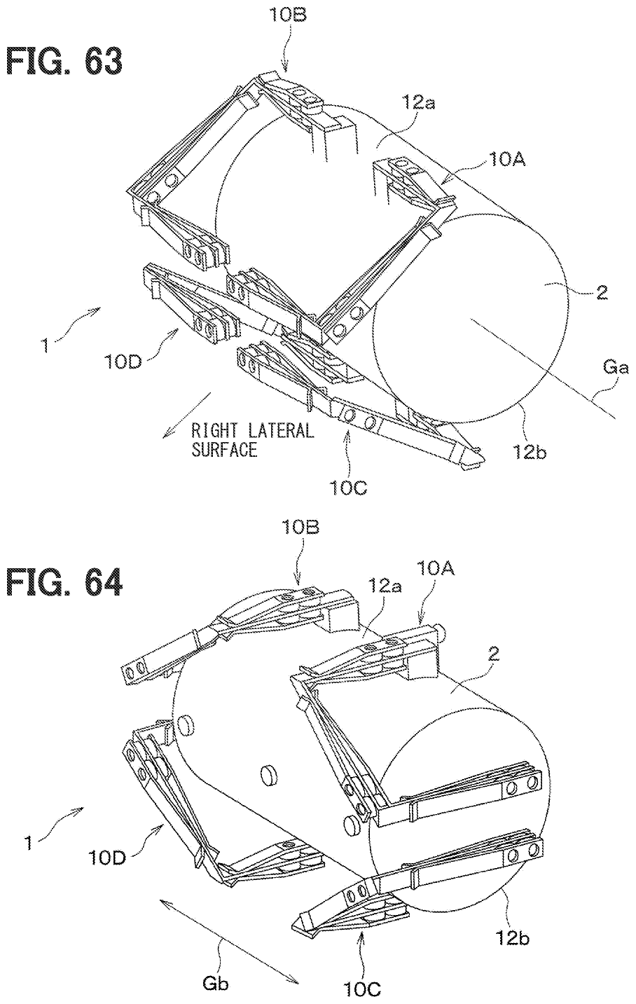

Alternatively, in a fifteenth embodiment (a modification of the fourteenth embodiment), as shown in FIG. 61, there may be used the spring unit 10A, in which a gap 135 shaped in a rectangular form is formed between the bent portion 120 of the coupling plate spring 20 and the bent portion 130 of the plate spring 30A.

### Sixteenth Embodiment

In the first embodiment described above, there is explained the example where the plate springs 30A, 30B, 30C are independently formed in the spring unit 10A.

Alternatively, with reference to FIG. 62, there will be described a sixteenth embodiment, in which the plate springs 30A, 30B, 30C are formed integrally in one-piece as a one-piece product in the spring unit 10A.

FIG. 62 shows an overall structure of the vehicular vibration isolator 1 of the present embodiment. In FIG. 62, the portions, which are the same as those of FIG. 25, are indicated by the same references signs as those of FIG. 25, and redundant description thereof will be omitted for the sake of simplicity.

In the spring unit 10A of the present embodiment, the plate springs 30A, 30B, 30C form a one-piece product 300 that is formed integrally in one-piece.

In the present embodiment, the one-piece product 300 is joined to and is fixed to the coupling plate spring 20 and the traveling engine 3 by the bolts 50a, 50b.

For example, in a case where the one-piece product 300 is joined to and is fixed to the coupling plate spring 20 only by one bolt 50a, the one-piece product 300 (i.e., the plate springs 30A, 30B, 30C) may be rotated relative to the coupling plate spring 20 at the time of fixing the one-piece product 300 to the coupling plate spring 20. In such a case, for example, the position of the frictional contact portion 33a will be deviated relative to the frictional contact portion 21c. Therefore, the frictional contact portion 33a is not in full contact with the frictional contact portion 21c.

In contrast, the one-piece product 300 of the present embodiment is joined to and is fixed to the coupling plate spring 20 and the traveling engine 3 by the bolts 50a, 50b. Therefore, the frictional contact portion 33a can be in full contact with the frictional contact portion 21c.

According to the present embodiment, in the spring unit 10A, the plate springs 30A, 30B, 30C form the one-piece product 300 that is formed integrally in one-piece. Therefore, the number of the components can be reduced. Thus, the manufacturing costs can be reduced.

Furthermore, the coupling plate spring 20 is joined to and is fixed to the compressor 2 by the bolts 55, 56.

In the sixteenth embodiment, there is described the example where the one-piece product 300 is joined to and is fixed to the coupling plate spring 20 and the traveling engine 3 by the bolts 50a, 50b. Specifically, in the present embodiment, only the plate spring 30A among the plate springs 30A, 30B, 30C of the one-piece product 300 is joined to and is fixed to the coupling plate spring 20 and the traveling engine 3 by the bolts 50a, 50b.

Alternatively, in a case where the plate springs 30A, 30B, 30C are formed independently, it may be modified as follows.

That is, any one of the plate springs 30A, 30B, 30C may be joined to and fixed to the coupling plate spring 20 and the traveling engine 3 by the bolts 50a, 50b.

### Other Embodiments

(1) In the first to sixteenth embodiments, there is described the example where the spring units 10A, 10B, 10C, 10D couple between the traveling engine 3 and the compressor 2 while the traveling engine 3 is located on the upper side of the compressor 2. However, the present disclosure should not be limited to this configuration, and the spring units 10A, 10B, 10C, 10D may be arranged like in any one of (a), (b), (c), (d), (e), (f) and (g) described below.

(a) As shown in FIG. s33, the spring units 10A, 10B, 10C, 10D may couple between the traveling engine 3, which is located on a right lateral surface side of the compressor 2, and the compressor 2.

Here, the spring units 10A, 10B are connected to an upper surface 12a of the compressor 2. The spring units 10C, 10D are connected to a lower surface 12b of the compressor 2. The right lateral surface side of the compressor 2 refers to one side of the compressor 2 in a radial direction of a central axis Ga of the compressor 2.

(b) As shown in FIG. 64, the spring units 10A, 10C may couple between an in-vehicle device, which is located on one side of the compressor 2 in the axial direction Gb, and the compressor 2. The spring units 10B, 10D may couple between an in-vehicle device, which is located on the other side of the compressor 2 in the axial direction Gb, and the compressor 2,

Here, the spring units 10A, 10B are connected to the upper surface 12a of the compressor 2, The spring units 10C, 10D are connected to the lower surface 12b of the compressor 2.

(c) As shown in FIG. 65, the spring units 10A, 10C may couple between the in-vehicle device, which is located on the one side of the compressor 2 in the axial direction Gb, and the compressor 2. The spring unit 10B may couple between the in-vehicle device, which is located on the other side of the compressor 2 in the axial direction Gb, and the compressor 2.

Here, the spring units 10A, 10B are connected to the upper surface 12a of the compressor 2. The spring unit 10C is connected to the lower surface 12b of the compressor 2.

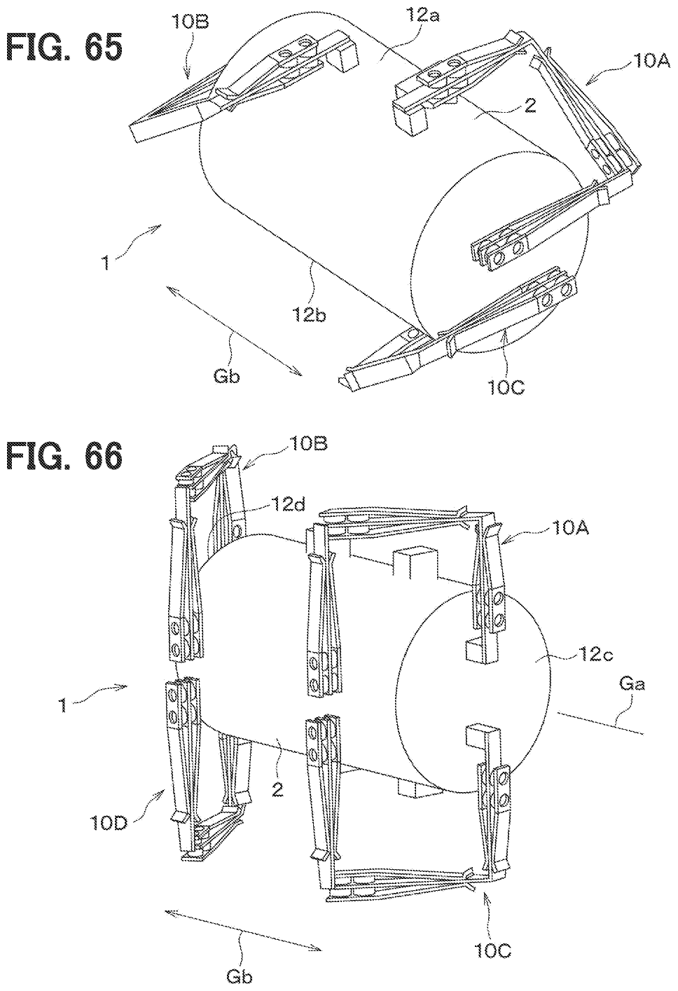

(d) As shown in FIG. 66, the spring units 10A, 10B, 10C, 10D may couple between the traveling engine 3, which is located on the right lateral surface side of the compressor 2, and the compressor 2. The right lateral surface side of the compressor 2 refers to the one side of the compressor 2 in the radial direction of the central axis Ga of the compressor 2,

In this case, the spring units 10A, 10C are connected to one side surface 12c of the compressor 2 which is located on the one side in the axial direction Gb. The spring units 10B, 10D are connected to the other side surface 12d of the compressor 2 which is located on the other side in the axial direction Gb.

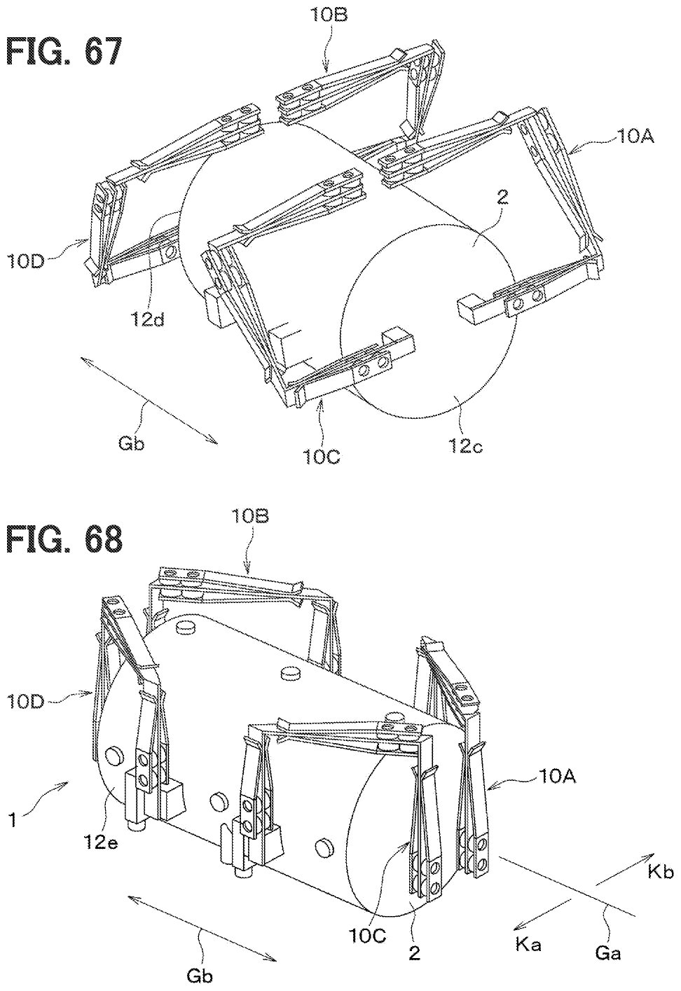

(e) As shown in FIG. 67, the spring units 10A, 10B, 10C, 10D may couple between the compressor 2, which is located on the lower side of the traveling engine 3, and the traveling engine 3.

In this case, the spring units 10A, 10C are connected to the one side surface 12c of the compressor 2 which is located on the one side in the axial direction Gb. The spring units 10B, 10D are connected to the other side surface 12d of the compressor 2 which is located on the other side in the axial direction Gb.

(f) As shown in FIG. 68, the spring units 10A, 10C may couple between the in-vehicle device, which is located on the one side of the compressor 2 in the axial direction Gb, and the compressor 2. The spring units 10B, 10D may couple between the in-vehicle device, which is located on the other side of the compressor 2 in the axial direction Gb, and the compressor 2.

In this case, the spring units 10C, 10D are connected to the one side Ka of the compressor 2 in the radial direction of the central axis Ga of the compressor 2. The spring units 10A, 10B are connected to the other side Kb of the compressor 2 in the radial direction of the central axis Ga of the compressor 2.

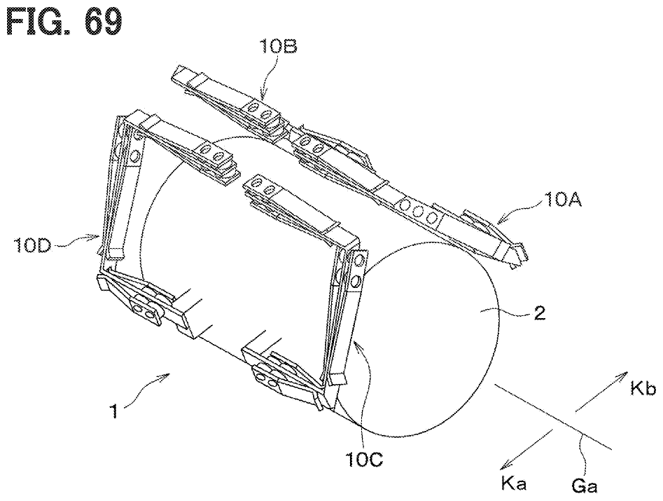

(g) As shown in FIG. 69, the spring units 10A, 10B, 10C, 10D may couple between the traveling engine 3, which is located on the upper side of the compressor 2, and the compressor 2.

In this case, the spring units 10C, 10D are connected to the one side Ka of the compressor 2 in the radial direction of the central axis Ga of the compressor 2. The spring units 10A, 10B are connected to the other side Kb of the compressor 2 in the radial direction of the central axis Ga of the compressor 2.

(2) In the first to sixteenth embodiments, there is described the example where the vibration isolator of the present disclosure is applied to the motor vehicle. However, the present disclosure should not be limited to this, and the vibration isolator of the present disclosure may be applied to various devices such as other types of vehicles (e.g., airplanes, trains), moving objects (e.g., machine tools) which are other than the motor vehicle.

(3) The present disclosure should not be limited to the above-described embodiments and can be appropriately modified within the scope of the present disclosure. In addition, the above embodiments are not irrelevant to each other and may be appropriately combined unless such a combination is clearly not possible. In each of the above embodiments, it is needless to say that the components constituting the embodiment are not necessarily essential, unless otherwise clearly indicated as essential or in principle considered to be clearly essential. In each of the above embodiments, when a numerical value such as the number, numerical value, amount, range or the like of the components of the embodiment is mentioned, the present disclosure should not be limited to such a numerical value unless it is clearly stated that it is essential and/or it is required in principle. In each of the above embodiments, when referring to the shape of the components and/or the positional relationship of the components, the present disclosure should not be limited to such a shape and positional relationship unless it is clearly stated that it is essential and/or it is required in principle.

(4) In the present disclosure, even in a case where the traveling engine 3 becomes a vibration source due to vibrations conducted from a road surface, and the compressor 2 becomes a vibration receiving object, the vibration isolating effect and the vibration attenuating effect, which are the same as those described above, can be achieved.

Furthermore, in the first and third to tenth embodiments, like in the second embodiment, the frictional contact portion 33a, 43a of the plate spring 30A, 40A may be replaced by a plurality of frictional contact portions 33a, 43a while a non-contact portion 35, 45, which does not contact the plate spring segment 21, is formed between each adjacent two of the plurality of frictional contact portions 33a, 43a. Likewise, the frictional contact portion 33b, 43b of the plate spring 30B, 40B may be replaced by a plurality of frictional contact portions 33b, 43b while a non-contact portion 35, 45, which does not contact the plate spring segment 22, is formed between each adjacent two of the plurality of frictional contact portions 33b, 43b. Also, the frictional contact portion 33c, 43c of the plate spring 30C, 40C may be replaced by a plurality of frictional contact portions 33c, 43c while a non-contact portion 35, 45, which does not contact the plate spring segment 23, is formed between each adjacent two of the plurality of frictional contact portions 33c, 43c.

Furthermore, in the first embodiment, the intervening portion of each of the plate springs 30A, 40A may be formed as the displacement enabling portion 70, 71 of any one of the third to tenth embodiments that projects from both of the fixing portion 36, 46 and the frictional contact portion 33a, 43a in the direction away from the plate spring segment 21. Likewise, the intervening portion of each of the plate springs 30B, 40B may be formed as the displacement enabling portion 70, 71 of any one of third to tenth embodiments that projects from both of the fixing portion 66, 76 and the frictional contact portion 33b, 43b in the direction away from the plate spring segment 22. Also, the intervening portion of each of the plate springs 30C, 40C may be formed as the displacement enabling portion 70, 71 of any one of the third to tenth embodiments that projects from both of the fixing portion 86, 96 and the frictional contact portion 33c, 43c in the direction away from the plate spring segment 23.

Furthermore, the bolts 50a, 50b, 51a, 51b, 52a, 52b of the first to sixteenth embodiments, which serve as fixtures, may be replaced with any other suitable type of fixtures, such as screws, rivets. Also, instead of using the bolts 50a, 50b, 51a, 51b, 52a, 52b, the plate springs 30A, 30B, 30C, 40A, 40B, 40C may be joined to and fixed to the coupling plate spring 20 by welding. Furthermore, in the first embodiment, the spacers 60a, 60b, 60c, 60d, 61a, 61 b, 61c, 61d, 62a, 62b, 62c, 62d are formed separately from the coupling plate spring 20. Alternatively, the spacers 60a, 60b, 60c, 60d, 61a, 61 b, 61c, 61d, 62a, 62b, 62c, 62d may be formed integrally with the coupling plate spring 20 from metal.

Furthermore, the first direction (e.g., the X direction), the second direction (e.g., the Y direction) and the third direction (e.g., the Z direction) do not need to intersect at 90 degrees. That is, the first direction, the second direction and the third direction may intersect at suitable angles other than 90 degrees.

Furthermore, the number of the spring units 10A, 108, 10C, 10D in the vibration isolator 1 in the above embodiments may be changed to any number depending on a need.

What is claimed is:

1. A vibration isolator configured to limit conduction of vibrations, which are generated at a vibration source, to a vibration receiving object, the vibration isolator comprising:
a coupling plate spring that has a first plate spring segment, a second plate spring segment and a third plate spring segment and is configured to couple between the vibration source and the vibration receiving object through the first plate spring segment, the second plate spring segment and the third plate spring segment;
a primary plate spring that is arranged to overlap the first plate spring segment in a first direction and is fixed to the first plate spring segment, wherein the primary plate spring has a primary frictional contact portion that is configured to generate sliding friction relative to the first plate spring segment in response to the vibrations;
a secondary plate spring that is arranged to overlap the second plate spring segment in a second direction and is fixed to the second plate spring segment while the second direction is different from the first direction, wherein the secondary plate spring has a secondary frictional contact portion that is configured to generate sliding friction relative to the second plate spring segment in response to the vibrations; and
a tertiary plate spring that is arranged to overlap the third plate spring segment in a third direction and is fixed to the third plate spring segment while the third direction is different from the first direction and the second direction, wherein the tertiary plate spring has a tertiary frictional contact portion that is configured to generate sliding friction relative to the third plate spring segment in response to the vibrations.

2. The vibration isolator according to claim 1, wherein:
the coupling plate spring is shaped in an elongated plate form that extends between the vibration source and the vibration receiving object;
an extending direction of the coupling plate spring is defined as a longitudinal direction, and a direction of the coupling plate spring, which is perpendicular to the longitudinal direction, is defined as a thickness direction, and a direction of the coupling plate spring, which is perpendicular to the longitudinal direction and is perpendicular to the thickness direction, is defined as a width direction;
the coupling plate spring has a fourth plate spring segment that does not overlap any one of the first plate spring segment, the second plate spring segment and the third plate spring segment; and
the fourth plate spring segment is shaped such that a size of the fourth plate spring segment, which is measured in the width direction, is larger than a size of any one of the first plate spring segment, the second plate spring segment and the third plate spring segment, which is measured in the width direction, or a size of the fourth plate spring segment, which is measured in the thickness direction, is larger than a size of any one of the first plate spring segment, the second plate spring segment and the third plate spring segment, which is measured in the thickness direction.

3. The vibration isolator according to claim 1, wherein one of the primary plate spring, the secondary plate spring and the tertiary plate spring is joined to and is fixed to the coupling plate spring by two or more bolts.

4. The vibration isolator according to claim 1, wherein the coupling plate spring forms a one-piece product, in which the first plate spring segment, the second plate spring segment and the third plate spring segment are formed integrally in one-piece.

5. The vibration isolator according to claim 1, wherein the primary plate spring, the secondary plate spring and the tertiary plate spring are formed integrally in one-piece as a one-piece product.

6. The vibration isolator according to claim 1, wherein:
the coupling plate spring is formed in one-piece;
a primary fixing portion of the primary plate spring is joined to and is fixed to the first plate spring segment while a primary intervening portion of the primary plate spring, which is located between the primary fixing portion and the primary frictional contact portion, is spaced from the first plate spring segment by a gap;
a secondary fixing portion of the secondary plate spring is joined to and is fixed to the second plate spring segment while a secondary intervening portion of the secondary plate spring, which is located between the secondary fixing portion and the secondary frictional contact portion, is spaced from the second plate spring segment by a gap; and
a tertiary fixing portion of the tertiary plate spring is joined to and is fixed to the third plate spring segment while a tertiary intervening portion of the tertiary plate spring, which is located between the tertiary fixing portion and the tertiay frictional contact portion, is spaced from the third plate spring segment by a gap.

7. The vibration isolator according to claim 6, wherein:
the primary fixing portion is spaced from the first plate spring segment by a spacer;
the secondary fixing portion is spaced from the second plate spring segment by a spacer; and
the tertiary fixing portion is spaced from the third plate spring segment by a spacer.

8. The vibration isolator according to claim 6, wherein:
the primary intervening portion projects from both of the primary fixing portion and the primary frictional contact portion in a direction away from the first plate spring segment;
the secondary intervening portion projects from both of the secondary fixing portion and the secondary frictional contact portion in a direction away from the second plate spring segment; and
the tertiary intervening portion projects from both of the tertiary fixing portion and the tertiary frictional contact portion in a direction away from the third plate spring segment.

9. The vibration isolator according to claim 6, wherein:
the primary plate spring is one of a pair of primary plate springs which are located on two opposite sides of the first plate spring segment in the first direction;
the secondary plate spring is one of a pair of secondary plate springs which are located on two opposite sides of the second plate spring segment in the second direction; and
the tertiary plate spring is one of a pair of tertiary plate springs which are located on two opposite sides of the third plate spring segment in the third direction.

10. The vibration isolator according to claim 6, wherein:
the primary frictional contact portion is one of a plurality of primary frictional contact portions of the primary plate spring while a non-contact portion, which does not contact the first plate spring segment, is formed between each adjacent two of the plurality of primary frictional contact portions of the primary plate spring;
the secondary frictional contact portion is one of a plurality of secondary frictional contact portions of the secondary plate spring while a non-contact portion, which does not contact the second plate spring segment, is formed between each adjacent two of the plurality of secondary frictional contact portions of the secondary plate spring; and
the tertiary frictional contact portion is one of a plurality of tertiary frictional contact portions of the tertiary plate spring while a non-contact portion, which does not contact the third plate spring segment, is formed between each adjacent two of the plurality of tertiary frictional contact portions of the tertiary plate spring.

11. A vibration isolator configured to limit conduction of vibrations, which are generated at a vibration source, to a vibration receiving object, the vibration isolator comprising:
a coupling plate spring that is configured to couple between the vibration source and the vibration receiving object; and
a plate spring that has:
a fixing portion, which is fixed to the coupling plate spring; and
a plurality of frictional contact portions, which are arranged to overlap the coupling plate spring at corresponding locations, respectively, that are different from a location of the fixing portion, wherein the plurality of frictional contact portions are respectively configured to generate sliding friction relative to the coupling plate spring in response to the vibrations.

12. A vibration isolator configured to limit conduction of vibrations, which are generated at a vibration source, to a vibration receiving object, the vibration isolator comprising:
a coupling plate spring that is configured to couple between the vibration source and the vibration receiving object; and
a plate spring that has:
a fixing portion, which is fixed to the coupling plate spring; and
a frictional contact portion, which is arranged to overlap the coupling plate spring at a corresponding location that is different from a location of the fixing portion, wherein the frictional contact portion is configured to generate sliding friction relative to the coupling plate spring in response to the vibrations in a state where a resilient force is applied from the plate spring to the coupling plate spring through resilient deformation of the plate spring.

13. A vibration isolator configured to limit conduction of vibrations, which are generated at a vibration source, to a vibration receiving object, the vibration isolator comprising:
a coupling plate spring that has a plate spring segment and is configured to couple between the vibration source and the vibration receiving object through the plate spring segment; and
a plate spring that has:
a fixing portion, which is fixed to the plate spring segment;
a frictional contact portion which is arranged to overlap the plate spring segment at a corresponding location that is different from a location of the fixing portion, wherein the frictional contact portion is configured to generate sliding friction relative to the plate spring segment in response to the vibrations; and
a displacement enabling portion which is configured to be resiliently deformed in response to the vibrations to displace the frictional contact portion relative to the plate spring segment.

14. The vibration isolator according to claim 13, wherein:
the plate spring segment extends in a predetermined direction; and
the displacement enabling portion is configured to be resiliently deformed in response to the vibrations to displace the frictional contact portion relative to the plate spring segment in the predetermined direction.

15. The vibration isolator according to claim 13, wherein:
the plate spring segment extends in a predetermined direction; and
the displacement enabling portion is configured to be resiliently deformed in response to the vibrations to displace the frictional contact portion relative to the plate spring segment in a direction that intersects the predetermined direction.

16. The vibration isolator according to claim 13, wherein the displacement enabling portion is spaced from the coupling plate spring by a gap.

17. The vibration isolator according to claim 13, wherein the plate spring is joined to and is fixed to the coupling plate spring by two or more bolts.
